(19) United States
(12) Patent Application Publication
(10) Pub. No.: US 2011/0213059 A1
(43) Pub. Date: Sep. 1, 2011

(54) Method for Producing Mono-Carboxyfunctionalized Dialkylphosphinic Acids and Esters and Salts Thereof by means of Vinylenes-Nitriles and Use Thereof

(75) Inventors: Michael Hill, Koeln (DE); Werner Krause, Huerth (DE); Martin Sicken, Koeln (DE)

(73) Assignee: CLARIANT FINANCE (BVI) LIMITED, Tortola (VG)

(21) Appl. No.: 13/125,363

(22) PCT Filed: Oct. 6, 2009
(86) PCT No.: PCT/EP2009/007128

§ 371 Date: Apr. 21, 2011

(30) Foreign Application Priority Data
Nov. 6, 2008 (DE) 10 2008 056 234.3
Oct. 6, 2009 (EP) PCT/EP2009/007128

(51) Int. Cl. C08K 5/5313; C07F 9/30; C07F 9/32

(52) U.S. Cl. 524/133; 562/24; 556/174; 556/20; 558/108; 558/179

(57) ABSTRACT

The invention relates to a method for producing mono-carboxyfunctional zed dialkylphosphinic acids and esters and salts thereof by means of vinylenes/nitriles, characterized in that a) a phosphinic acid source (I) is reacted with olefins (IV) to yield an alkylphosphonic acid, salt or ester (II) thereof in the presence of a catalyst A, b) the thus obtained alkylphosphonic acid, salt or ester (II) thereof is reacted with acetylenic compounds of formula (V) to yield a mono-functionalized dialkylphosphinic acid derivative (VI) in the presence of a catalyst B, and c) the thus obtained mono-functionalized dialkylphosphinic acid derivative (VI) is reacted with a hydrogen cyanide source to yield a mono-functionalized dialkylphosphinic acid derivative (VII) in the presence of a catalyst C, and d) the thus obtained monofunctionalized dialkylphosphinic acid derivative (VII); is reacted to yield a monocarboxyfunctionalized dialkylphosphinic acid derivative (III) in the presence of a catalyst D, wherein R¹, R², R³, R⁴, R⁵, R⁶ are the same or different and stand independently of each other, among other things, for H, C₁-C₁₈ alkyl, C₆-C₁₈ aryl, C₆-C₁₈ aralkyl, C₆-C₁₈ alkylaryl, and X and Y are the same or different and stand independently of each other for H, C₁-C₁₈ alkyl, C₆-C₁₈ aryl, C₆-C₁₈ aralkyl, C₆-C₁₈ alkylaryl, Mg, Ca, Al, Sb, Sn, Ge, Ti, Fe, Zr, Zn, Ce, Bi, Sr, Mn, Cu, Ni, Li, Na, K and/or a protonized nitrogen base, and the catalysts A, B and C are formed by transition metals and/or transition metal compounds and/or catalyst systems composed of a transition metal and/or a transition metal compound and at least one ligand, and the catalyst D is an acid or a base.

This invention relates to a method for producing monocarboxy-functionalized dialkylphosphinic acids, esters and salts by means of vinyls/nitriles and also to their use.

There are certain dialkylphosphinic acids, known as monocarboxy-functionalized dialkylphosphinic acids, as hereinbelow defined, of which hitherto very substantially only the esters are available. The latter are obtainable via multiple steps proceeding from phosphonous dihalides. These include reaction of dihalophosphines with activated olefinic compounds such as acrylic acid followed by the esterification with alcohols of the acid chloride and anhydride derivatives initially formed (V. K. Khairullin, R. R. Shagidullin, Zh. Obshch. Khim. 36, 289-296).

Dialkylphosphinic acids for the purposes of the present invention are thus always monocarboxy-functionalized dialkylphosphinic acids even where this is not expressly mentioned. This definition includes the corresponding esters and salts.

Such dialkylphosphinic esters are also obtained on adding phosphonous esters onto α,β-unsaturated carboxylic esters in the presence of peroxidic catalysts (Houben-Weyl, volume 1211, pages 258-259). The phosphonous esters themselves are prepared from phosphonous dihalides by reaction with alcohols, or hydrolysis, and subsequent esterification. The aforementioned phosphonous dihalides themselves are prepared in a costly and inconvenient synthesis from phosphoryl trichloride and alkyl chloride in the presence of aluminum chloride (Houben-Weyl, volume 1211, page 306). The reaction is strongly exothermic and difficult to control on an industrial scale. In addition, the reaction by-produces various products which, like some of the aforementioned starting materials also, are toxic and/or corrosive, i.e., extremely undesirable (particularly since the products are not obtainable free of halogen).

A further method for producing monocarboxy-functionalized dialkylphosphinic esters is based on the reaction of yellow phosphorus with methyl chloride to form methylphosphonous acid which is then esterified and thereafter reacted with acrylic ester (DE-A-101 53 780).

Monocarboxy-functionalized dialkylphosphinic esters are also obtainable by reaction of bis(trimethylsilyl)phosphonite —HP(OSiMe₃)₂— with α,β-unsaturated carboxylic acid components, subsequent alkylation with alkyl halides by the Arbuzov reaction and alcoholysis (Kurdyumova, N. R.; Rozhko, L. F.; Ragulin, V. V.; Tsvetkov, E. N.; Russian Journal of General Chemistry (Translation of Zhurnal Obshchei Khimii (1997), 67(12), 1852-1856). The bis(trimethylsilyl) phosphonite ester is obtained from potassium or ammonium hypophosphite by reaction with hexamethyldisilazane.

Hitherto there are no methods in existence for producing monocarboxyfunctionalized dialkylphosphinic acids, esters and salts that are available economically and on a large industrial scale and more particularly enable a high space-time yield to be achieved. Nor are there any methods that are sufficiently effective without unwelcome halogen compounds as starting materials, nor any where the end products are easy to obtain or isolate or else obtainable in a specific and desirable manner under controlled reaction conditions (such as a transesterification for example).

We have found that this object is achieved by a method for producing monocarboxy-functionalized dialkylphosphinic acids, esters and salts, which comprises

a) reacting a phosphinic acid source (I)

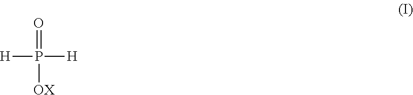

with olefins (IV)

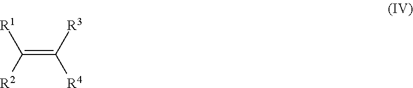

in the presence of a catalyst A to form an alkylphosphonous acid, salt or ester II

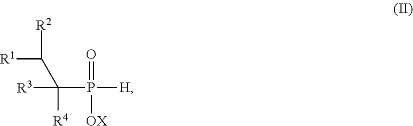

b) reacting the resulting alkylphosphonous acid, salt or ester (II) with acetylenic compounds of the formula (V) in the presence of a catalyst B

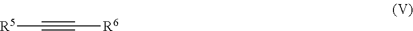

to form a monofunctionalized dialkylphosphinic acid derivative (VI)

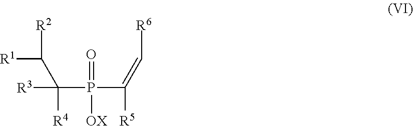

and
c) reacting the resulting monofunctionalized dialkylphosphinic acid derivative (VI) with a hydrogen cyanide source in the presence of a catalyst C to form the monofunctionalized dialkylphosphinic acid derivative (VII)

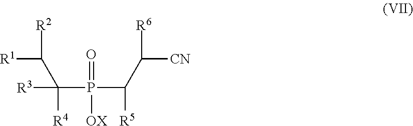

and
d) reacting the resulting monofunctionalized dialkylphosphinic acid derivative (VII) in the presence of a catalyst D to form the monocarboxy-functionalized dialkylphosphinic acid derivative (III)

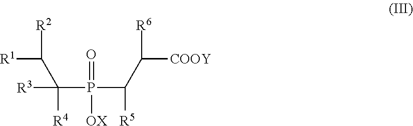

where R¹, R², R³, R⁴, R⁵, R⁶ are identical or different and are each independently H, C₁-C₁₈-alkyl, C₆-C₁₈-aryl, C₈-C₁₈-aralkyl, C₆-C₁₈-alkylaryl, CN, CHO, OC(O)CH₂CN, CH(OH)C₂H₅, CH₂CH(OH)CH₃, 9-anthracene, 2-pyrrolidone, (CH₂)ₘOH, (CH₂)ₘNH₂, (CH₂)ₘNCS, (CH₂)ₘNC(S)NH₂, (CH₂)ₘSH, (CH₂)ₘS-2-thiazoline, (CH₂)ₘSiMe₃, C(O)R⁷, (CH₂)ₘC(O)R⁷, CH═CHR⁷ and/or CH═CH—C(O)R⁷ and where R⁷ is C₁-C₈-alkyl or C₆-C₁₈-aryl and m is an integer from 0 to 100 and X and Y are identical or different and are each independently H, C₁-C₁₈-alkyl, C₆-C₁₅-aryl, C₈-C₁₈-aralkyl, C₆-C₁₈-alkylaryl, (CH₂)ₖOH, CH₂—CHOH—CH₂OH, (CH₂)ₖ—O—(CH₂)ₖH, (CH₂)ₖ—CH(OH)—(CH₂)ₖH, (CH₂—CH₂O)ₖH, (CH₂—C[CH₃]HO)ₖH, (CH₂—C[CH₃]HO)ₖ(CH₂—CH₂O)ₖH, (CH₂—CH₂O)ₖ(CH₂—C[CH₃]HO)H, (CH₂—CH₂O)ₖ-alkyl, (CH₂—C[CH₃]HO)ₖ-alkyl, (CH₂—C[CH₃]HO)ₖ(CH₂—CH₂O)ₖ-alkyl, (CH₂—CH₂O)ₖ(CH₂—C[CH₃]HO)O-alkyl, (CH₂)ₖ—CH═CH(CH₂)ₖH, (CH₂)ₖNH₂ and/or (CH₂)ₖN[(CH₂)ₖH]₂, where k is an integer from 0 to 10, and/or Mg, Ca, Al, Sb, Sn, Ge, Ti, Fe, Zr, Zn, Ce, Bi, Sr, Mn, Cu, Ni, Li, Na, K, H and/or a protonated nitrogen base and the catalysts A, B and C comprise transition metals and/or transition metal compounds and/or catalyst systems composed of a transition metal and/or transition metal compound and at least one ligand, and the catalyst D comprises an acid or a base.

Preferably, the monocarboxy-functionalized dialkylphosphinic acid, its salt or ester (III) obtained after step d) is subsequently reacted in a step e) with metal compounds of Mg, Ca, Al, Sb, Sn, Ge, Ti, Fe, Zr, Zn, Ce, Bi, Sr, Mn, Li, Na, K and/or a protonated nitrogen base to form the corresponding monocarboxyfunctionalized dialkylphosphinic acid salts (III) of these metals and/or of a nitrogen compound.

Preferably, the alkylphosphonous acid, salt or ester (II) obtained after step a) and/or the monofunctionalized dialkylphosphinic acid, salt or ester (VI) obtained after step b) and/or the monofunctionalized dialkylphosphinic acid, salt or ester (VII) obtained after step c) and/or the monocarboxy-functionalized dialkylphosphinic acid, salt or ester (III) obtained after step d) and/or the particular resulting reaction solution thereof are esterified with an alkylene oxide or an alcohol M-OH and/or M′-OH, and the respectively resulting alkylphosphonous ester (II), monofunctionalized dialkylphosphinic ester (VI), monofunctionalized dialkylphosphinic ester (VII) and/or monocarboxy-functionalized dialkylphosphinic ester (III) are subjected to the further reaction steps b), c), d) or e).

Preferably, the groups C₆-C₁₈-aryl, C₆-C₁₈-aralkyl and C₆-C₁₈-alkylaryl are substituted with SO₃X₂, —C(O)CH₃, OH, CH₂OH, CH₃SO₃X₂, PO₃X₂, NO₂, OCH₃, SH and/or OC(O)CH₃.

Preferably, R¹, R², R³, R⁴, R⁵, R⁶ are identical or different and are each independently H, methyl, ethyl, n-propyl, isopropyl, n-butyl, isobutyl, tert-butyl and/or phenyl.

Preferably, X and Y are identical or different and are each H, Ca, Mg, Al, Zn, Ti, Mg, Ce, Fe, methyl, ethyl, n-propyl, isopropyl, n-butyl, isobutyl, tert-butyl, phenyl, ethylene glycol, propyl glycol, butyl glycol, pentyl glycol, hexyl glycol, allyl and/or glycerol.

Preferably m=1 to 10 and k 2 to 10.

Preferably, the catalyst systems A, B and C are each formed by reaction of a transition metal and/or of a transition metal compound and at least one ligand.

Preferably, the transition metals and/or transition metal compounds comprise such from the first, seventh and eighth transition groups.

Preferably, the transition metals and/or transition metal compounds comprise rhodium, nickel, palladium, ruthenium and/or copper.

Preferably, the catalyst D comprises metals, metal hydrides, metal hydroxides and metal alkoxides and mineral acids, for example sulfuric acid, nitric acid, hydrochloric acid, phosphoric acid or mixtures thereof.

Preferably, the acetylenic compounds (V) comprise acetylene, methylacetylene, 1-butyne, 1-hexyne, 2-hexyne, 1-octyne, 4-octyne, 1-butyn-4-ol, 2-butyn-1-ol, 3-butyn-1-ol, 5-hexyn-1-ol, 1-octyn-3-ol, 1-pentyne, phenylacetylene, trimethylsilylacetylene.

Preferably, the hydrogen cyanide sources comprise hydrogen cyanide, acetone cyanohydrin, formamide and/or their alkali and/or alkaline earth metal salts.

Preferably, the alcohol of the general formula M-OH comprises linear or branched, saturated and unsaturated, monohydric organic alcohols having a carbon chain length of C₁-C₁₈ and the alcohol of the general formula M′—OH comprises linear or branched, saturated and unsaturated polyhydric organic alcohols having a carbon chain length of C₁-C₁₈.

The present invention also provides for the use of monocarboxy-functionalized dialkylphosphinic acids, esters and salts obtained according to one or more of claims 1 to 12 as an intermediate for further syntheses, as a binder, as a crosslinker or accelerant to cure epoxy resins, polyurethanes and unsaturated polyester resins, as polymer stabilizers, as crop protection agents, as a therapeutic or additive in therapeutics for humans and animals, as a sequestrant, as a mineral oil additive, as a corrosion control agent, in washing and cleaning applications and in electronic applications.

The present invention likewise provides for the use of monocarboxy-functionalized dialkylphosphinic acids, salts and esters (III) obtained according to one or more of claims 1 to 12 as a flame retardant, more particularly as a flame retardant for clearcoats and intumescent coatings, as a flame retardant for wood and other cellulosic products, as a reactive and/or nonreactive flame retardant for polymers, in the manufacture of flame-retardant polymeric molding materials, in the manufacture of flame-retardant polymeric molded articles and/or for flame-retardant finishing of polyester and cellulose straight and blend fabrics by impregnation.

The present invention also provides a flame-retardant thermoplastic or thermoset polymeric molding material containing 0.5% to 45% by weight of monocarboxyfunctionalized dialkylphosphinic acids, salts or esters (III) obtained according to one or more of claims 1 to 12, 0.5% to 95% by weight of thermoplastic or thermoset polymer or mixtures thereof, 0% to 55% by weight of additives and 0% to 55% by weight of filler or reinforcing materials, wherein the sum total of the components is 100% by weight.

Lastly, the invention also provides flame-retardant thermoplastic or thermoset polymeric molded articles, films, threads and fibers containing 0.5% to 45% by weight of monocarboxy-functionalized dialkylphosphinic acids, salts or esters (III) obtained according to one or more of claims 1 to 12, 0.5% to 95% by weight of thermoplastic or thermoset polymer or mixtures thereof, 0% to 55% by weight of additives and 0% to 55% by weight of filler or reinforcing materials, wherein the sum total of the components is 100% by weight.

All the aforementioned reactions can also be carried out in stages; similarly, the various processing steps can also utilize the respective resulting reaction solutions.

When the monocarboxy-functionalized dialkylphosphinic acid (III) after step d) comprises an ester, an acidic or basic hydrolysis may preferably be carried out in order that the free monocarboxy-functionalized dialkylphosphinic acid or salt may be obtained.

Preferably, the monocarboxy-functionalized dialkylphosphinic acid comprises 3-(ethylhydroxyphosphinyl)propionic acid, 3-(propylhydroxyphosphinyl)propionic acid, 3-(i-propylhydroxyphosphinyl)propionic acid, 3-(butylhydroxyphosphinyl)propionic acid, 3-(sec-butylhydroxyphosphinyl)propionic acid, 3-(1-butylhydroxyphosphinyl)propionic acid, 3-(2-phenylethylhydroxyphosphinyl)propionic acid, 3-(ethylhydroxyphosphinyl)-2-methylpropionic acid, 3-(propylhydroxyphosphinyl)-2-methylpropionic acid, 3-(i-propylhydroxyphosphinyl)-2-methylpropionic acid, 3-(butylhydroxyphosphinyl)-2-methylpropionic acid, 3-(sec-butylhydroxyphosphinyl)-2-methylpropionic acid, 3-(i-butylhydroxyphosphinyl)-2-methylpropionic acid, 3-(2-phenylethylhydroxyphosphinyl)-2-methylpropionic acid, 3-(ethylhydroxyphosphinyl)-3-phenylpropionic acid, 3-(propylhydroxyphosphinyl)-3-phenylpropionic acid, 3-(i-propylhydroxyphosphinyl)-3-phenylpropionic acid, 3-(butylhydroxyphosphinyl)-3-phenylpropionic acid, 3-(i-butylhydroxyphosphinyl)-3-phenylpropionic acid, 3-(sec-butylhydroxyphosphinyl)-3-phenylpropionic acid, 3-(2-phenylethylhydroxyphosphinyl)-3-phenylpropionic acid.

Preferably, the monocarboxy-functionalized dialkylphosphinic ester comprises a propionic acid, methyl, ethyl; i-propyl; butyl, phenyl; 2-hydroxyethyl, 2-hydroxypropyl, 3-hydroxypropyl, 4-hydroxybutyl and/or 2,3-dihydroxypropyl ester of the aforementioned monocarboxy-functionalized dialkylphosphinic acids or mixtures thereof.

Preferably, the monocarboxy-functionalized dialkylphosphinic salt comprises an aluminum(III), calcium(II), magnesium(II), cerium(III), titanium(IV) and/or zinc(II) salt of the aforementioned monocarboxy-functionalized dialkylphosphinic acids or esters.

Target compounds also include those esters and salts where the esterification and salt formation, respectively, takes place on the phosphinic acid group (at X in formula (III)) or on the propionic acid group (at Y in formula (III)).

Preferably, the transition metals for catalyst A comprise elements of the seventh and eighth transition groups (a metal of group 7, 8, 9 or 10, in modern nomenclature), for example rhenium, ruthenium, cobalt, rhodium, iridium, nickel, palladium and platinum.

Preference for use as source of the transition metals and transition metal compounds is given to their metal salts. Suitable salts are those of mineral acids containing the anions fluoride, chloride, bromide, iodide, fluorate, chlorate, bromate, iodate, fluorite, chlorite, bromite, iodite, hypofluorite, hypochlorite, hypobromite, hypoiodite, perfluorate, perchlorate, perbromate, periodate, cyanide, cyanate, nitrate, nitride, nitrite, oxide, hydroxide, borate, sulfate, sulfite, sulfide, persulfate, thiosulfate, sulfamate, phosphate, phosphite, hypophosphite, phosphide, carbonate and sulfonate, for example methanesulfonate, chlorosulfonate, fluorosulfonate, trifluoromethanesulfonate, benzenesulfonate, naphthylsulfonate, toluenesulfonate, t-butylsulfonate, 2-hydroxypropanesulfonate and sulfonated ion exchange resins; and/or organic salts, for example acetylacetonates and salts of a carboxylic acid having up to 20 carbon atoms, for example formate, acetate, propionate, butyrate, oxalate, stearate and citrate including halogenated carboxylic acids having up to 20 carbon atoms, for example trifluoroacetate, trichloroacetate.

A further source of the transition metals and transition metal compounds is salts of the transition metals with tetraphenylborate and halogenated tetraphenylborate anions, for example perfluorophenylborate.

Suitable salts similarly include double salts and complex salts consisting of one or more transition metal ions and independently one or more alkali metal, alkaline earth metal, ammonium, organic ammonium, phosphonium and organic phosphonium ions and independently one or more of the abovementioned anions. Examples of suitable double salts are ammonium hexachloropalladate and ammonium tetrachloropalladate.

Preference for use as a source of the transition metals is given to the transition metal as an element and/or a transition metal compound in its zerovalent state.

Preferably, the transition metal salt is used as a metal, or as an alloy with further metals, in which case boron, zirconium, tantalum, tungsten, rhenium, cobalt, iridium, nickel, palladium, platinum and/or gold is preferred here. The transition metal content in the alloy used is preferably 45-99.95% by weight.

Preferably, the transition metal is used in microdisperse form (particle size 0.1 mm-100 μm).

Preferably, the transition metal is used supported on a metal oxide such as, for example, alumina, silica, titanium dioxide, zirconium dioxide, zinc oxide, nickel oxide, vandium oxide, chromium oxide, magnesium oxide, Celite®, diatomaceous earth, on a metal carbonate such as, for example, barium carbonate, calcium carbonate, strontium carbonate, on a metal sulfate such as for example, barium sulfate, calcium sulfate, strontium sulfate, on a metal phosphate such as, for example, aluminum phosphate, vanadium phosphate, on a metal carbide such as, for example, silicone carbide, on a metal aluminate such as, for example, calcium aluminate, on a metal silicate such as, for example, aluminum silicate, chalks, zeolites, bentonite, montmorillonite, hectorite, on functionalized silicates, functionalized silica gels such as, for example, SiliaBond®, QuadraSil™, on functionalized polysiloxanes such as, for example, Deloxan®, on a metal nitride, on carbon, activated carbon, mullite, bauxite, antimonite, scheelite, perovskite, hydrotalcite, heteropolyanions, on functionalized and unfunctionalized cellulose, chitosan, keratin, heteropolyanions, on ion exchangers such as, for example, Amberlite™, Amberjet™, Ambersep™, Dowex®, Lewatit®, ScavNet®, on functionalized polymers such as, for example, Chelex®, QuadraPure™, Smopex®, PolyOrgs®, on polymer-bound phosphanes, phosphane oxides, phosphinates, phosphonates, phosphates, amines, ammonium salts, amides, thioamides, ureas, thioureas, triazines, imidazoles, pyrazoles, pyridines, pyrimidines, pyrazines, thiols, thiol ethers, thiol esters, alcohols, alkoxides, ethers, esters, carboxylic acids, acetates, acetals, peptides, hetarenes, polyethyleneimine/silica and/or dendrimers.

Suitable sources for the metal salts and/or transition metals likewise preferably include their complex compounds. Complex compounds of the metal salts and/or transition metals are composed of the metal salts/transition metals and one or moe complexing agents. Suitable complexing agents include for example olefins, diolefins, nitriles, dinitriles, carbon monoxide, phosphines, diphosphines, phosphites, diphosphites, dibenzylideneacetone, cyclopentadienyl, indenyl or styrene. Suitable complex compounds of the metal salts and/or transition metals may be supported on the abovementioned support materials.

The proportion in which the supported transition metals mentioned are present is preferably in the range from 0.01% to 20% by weight, more preferably from 0.1% to 10% by weight and even more preferably from 0.2% to 5% by weight, based on the total mass of the support material.

Suitable sources for transition metals and transition metal compounds include for example

palladium, platinum, nickel, rhodium; palladium platinum, nickel or rhodium, on alumina, on silica, on barium carbonate, on barium sulfate, on calcium carbonate, on strontium carbonate, on carbon, on activated carbon; platinum-palladium-gold alloy, aluminum-nickel alloy, iron-nickel alloy, lanthanide-nickel alloy, zirconiumnickel alloy, platinum-iridium alloy, platinum-rhodium alloy; Raney® nickel, nickelzinc-iron oxide; palladium(II) chloride, palladium(II) bromide, palladium(II) iodide, palladium(II) fluoride, palladium(II) hydride, palladium(II) oxide, palladium(II) peroxide, palladium(II) cyanide, palladium(II) sulfate, palladium(II) nitrate, palladium(II) phosphide, palladium(II) boride, palladium(II) chromium oxide, palladium(II) cobalt oxide, palladium(II) carbonate hydroxide, palladium(II) cyclohexane butyrate, palladium(II) hydroxide, palladium(II) molybdate, palladium(II) octanoate, palladium(II) oxalate, palladium(II) perchlorate, palladium(II) phthalocyanine, palladium(II) 5,9,14,18,23,27,32,36-octabutoxy-2,3-naphthalocyanine, palladium(II) sulfamate, palladium(II) perchlorate, palladium(II) thiocyanate, palladium(II) bis(2,2,6,6-tetramethyl-3,5-heptanedionate), palladium(II) propionate, palladium(II) acetate, palladium(II) stearate, palladium(II) 2-ethylhexanoate, palladium(II) acetylacetonate, palladium(II) hexafluoroacetylacetonate, palladium(II) tetrafluoroborate, palladium(II) thiosulfate, palladium(II) trifluoroacetate, palladium(II) phthalocyaninetetrasulfonic acid tetrasodium salt, palladium(II) methyl, palladium(II) cyclopentadienyl, palladium(II) methylcyclopentadienyl, palladium(II) ethylcyclopentadienyl, palladium(II) pentamethylcyclopentadienyl, palladium(II) 2,3,7,8,12,13,17,18-octaethyl-21H,23H-porphine, palladium(II) 5,10,15,20-tetraphenyl-21H,23H-porphine, palladium(II) bis(5-[[4-(dimethylamino)phenyl]imino]-8(5H)-quinolinone), palladium(II) 2,11,20,29-tetra-tert-butyl-2,3-naphthalocyanine, palladium(II) 2,9,16,23-tetraphenoxy-29H,31H-phthalocyanine, palladium(II) 5,10,15,20-tetrakis(pentafluorophenyl)-21H,23H-porphine and the 1,4-bis(diphenylphosphine)butane, 1,3-bis(diphenylphosphino)propane, 2-(2′-di-tert-butylphosphine)biphenyl, acetonitrile, benzonitrile, ethylenediamine, chloroform, 1,2-bis(phenylsulfinyl)ethane, 1,3-bis(2,6-diisopropylphenyl)imidazolidene)(3-chloropyridyl), 2′-(dimethylamino)-2-biphenylyl, dinorbornylphosphine, 2-(dimethylaminomethyl)ferrocene, allyl, bis(diphenylphosphino)butane, (N-succinimidyl)bis(triphenylphosphine), dimethylphenylphosphine, methyldiphenylphosphine, 1,10-phenanthroline, 1,5-cyclooctadiene, N,N,N′,N′-tetramethylethylenediamine, triphenylphosphine, tri-o-tolylphosphine, tricyclohexylphosphine, tributylphosphine, triethylphosphine, 2,2′-bis(diphenylphosphino)-1,1′-binaphthyl, 1,3-bis(2,6-diisopropylphenyl)imidazol-2-ylidene, 1,3-bis(mesityl)imidazol-2-ylidene, 1,1′-bis(diphenylphosphino)ferrocene, 1,2-bis(diphenylphosphino)ethane, N-methylimidazole, 2,2′-bipyridine, (bicyclo[2.2.1]hepta-2,5-diene), bis(di-tert-butyl(4-dimethylaminophenyl)phosphine), bis(tert-butyl isocyanide), 2-methoxyethyl ether, ethylene glycol dimethyl ether, 1,2-dimethoxyethane, bis(1,3-diamino-2-propanol), bis(N,N-diethylethylenediamine), 1,2-diaminocyclohexane, pyridine, 2,2′:6′,2″-terpyridine diethyl sulfide, ethylene and amine complexes thereof; nickel(II) chloride, nickel(II) bromide, nickel(II) iodide, nickel(II) fluoride, nickel(II) hydride, nickel(II) oxide, nickel(II) peroxide, nickel(II) cyanide, nickel(II) sulfate, nickel(II) nitrate, nickel(II) phosphide, nickel(II) boride, nickel(II) chromium oxide, nickel(II) cobalt oxide, nickel(II) carbonate hydroxide, nickel(II) cyclohexane butyrate, nickel(II) hydroxide, nickel(II) molybdate, nickel(II) octanoate, nickel(II) oxalate, nickel(II) perchlorate, nickel(II) phthalocyanine, nickel(II) 5,9,14,18,23,27,32,36-octabutoxy-2,3-naphthalocyanine, nickel(II) sulfamate, nickel(II) perchlorate, nickel(II) thiocyanate, nickel(II) bis(2,2,6,6-tetramethyl-3,5-heptanedionate), nickel(II) propionate, nickel(II) acetate, nickel(II) stearate, nickel(II) 2-ethylhexanoate, nickel(II) acetylacetonate, nickel(II) hexafluoroacetylacetonate, nickel(II) tetrafluoroborate, nickel(II) thiosulfate, nickel(II) trifluoroacetate, nickel(II) phthalocyaninetetrasulfonic acid tetrasodium salt, nickel(II) methyl, nickel(II) cyclopentadienyl, nickel(II) methylcyclopentadienyl, nickel(II) ethylcyclopentadienyl, nickel(II) pentamethylcyclopentadienyl, nickel(II) 2,3,7,8,12,13,17,18-octaethyl-21H,23H-porphine, nickel(II) 5,10,15,20-tetraphenyl-21H,23H-porphine, nickel(II) bis(5-[[4-(dimethylamino)phenyl]imino]-8(5H)quinolinone), nickel(II) 2,11,20,29-tetra-tert-butyl-2,3-naphthalocyanine, nickel(II) 2,9,16,23-tetraphenoxy-29H,31H-phthalocyanine, nickel(II) 5,10,15,20-tetrakis(pentafluorophenyl)-21H,23H-porphine and the 1,4-bis(diphenylphosphine)butane, 1,3-bis(diphenylphosphino)propane, 2-(2′-di-tert-butylphosphine)biphenyl, acetonitrile, benzonitrile, ethylenediamine, chloroform, 1,2-bis(phenylsulfinyl)ethane, 1,3-bis(2,6-diisopropylphenyl)imidazolidene)(3-chloropyridyl), 2′-(dimethylamino)-2-biphenylyl, dinorbornylphosphine, 2-(dimethylaminomethyl)ferrocene, allyl, bis(diphenylphosphino)butane, (N-succinimidyl)bis(triphenylphosphine), dimethylphenylphosphine, methyldiphenylphosphine, 1,10-phenanthroline, 1,5-cyclooctadiene, N,N,N′,N′-tetramethylethylenediamine, triphenylphosphine, tri-o-tolylphosphine, tricyclohexylphosphine, tributylphosphine, triethylphosphine, 2,2′-bis(diphenylphosphino)-1,1′-binaphthyl, 1,3-bis(2,6-diisopropylphenyl)imidazol-2-ylidene, 1,3-bis(mesityl)imidazol-2-ylidene, 1,1′-bis(diphenylphosphino)ferrocene, 1,2-bis(diphenylphosphino)ethane, N-methylimidazole, 2,2′-bipyridine, (bicyclo[2.2.1]hepta-2,5-diene), bis(di-tert-butyl(4-dimethylaminophenyl)phosphine), bis(tert-butyl isocyanide), 2-methoxyethyl ether, ethylene glycol dimethyl ether, 1,2-dimethoxyethane, bis(1,3-diamino-2-propanol), bis(N,N-diethylethylenediamine), 1,2-diaminocyclohexane, pyridine, 2,2′:6′,2″-terpyridine, diethyl sulfide, ethylene and amine complexes thereof; platinum(II) chloride, platinum(II) bromide, platinum(II) iodide, platinum(II) fluoride, platinum(II) hydride, platinum(II) oxide, platinum(II) peroxide, platinum(II) cyanide, platinum(II) sulfate, platinum(II) nitrate, platinum(II) phosphide, platinum(II) boride, platinum(II) chromium oxide, platinum(II) cobalt oxide, platinum(II) carbonate hydroxide, platinum(II) cyclohexane butyrate, platinum(II) hydroxide, platinum(II) molybdate, platinum(II) octanoate, platinum(II) oxalate, platinum(II) perchlorate, platinum(II) phthalocyanine, platinum(II) 5,9,14,18,23,27,32,36-octabutoxy-2,3-naphthalocyanine, platinum(II) sulfamate, platinum(II) perchlorate, platinum(II) thiocyanate, platinum(II) bis(2,2,6,6-tetramethyl-3,5-heptanedionate), platinum(II) propionate, platinum(II) acetate, platinium(II) stearate, platinium(II) 2-ethylhexanoate, platinium(II) acetylacetonate, platinum(II) hexafluoroacetylacetonate, platinum(II) tetrafluoroborate, platinum(II) thiosulfate, platinum(II) trifluoroacetate, platinum(II) phthalocyaninetetrasulfonic acid tetrasodium salt, platinum(II) methyl, platinum(II) cyclopentadienyl, platinum(II) methylcyclopentadienyl, platinum(II) ethylcyclopentadienyl, platinum(II) pentamethylcyclopentadienyl, platinum(II) 2,3,7,8,12,13,17,18-octaethyl-21H,23H-porphine, platinum(II) 5,10,15,20-tetraphenyl-21H,23H-porphine, platinum(II) bis(5-[[4-(dimethylamino)phenyl]imino]-8(5H)-quinolinone), platinum(II) 2,11,20,29-tetra-tert-butyl-2,3-naphthalocyanine, platinum(II) 2,9,16,23-tetraphenoxy-29H,31H-phthalocyanine, platinum(II) 5,10,15,20-tetrakis(pentafluorophenyl)-21H,23H-porphine and the 1,4-bis(diphenylphosphine)butane, 1,3-bis(diphenylphosphino)propane, 2-(2′-di-tert-butylphosphine)biphenyl, acetonitrile, benzonitrile, ethylenediamine, chloroform, 1,2-bis(phenylsulfinyl)ethane, 1,3-bis(2,6-diisopropylphenyl)imidazolidene)(3-chloropyridyl), 2′-(dimethylamino)-2-biphenylyl, dinorbornylphosphine, 2-(dimethylaminomethyl)ferrocene, allyl, bis(diphenylphosphino)butane, (N-succinimidyl)bis(triphenylphosphine), dimethylphenylphosphine, methyldiphenylphosphine, 1,10-phenanthroline, 1,5-cyclooctadiene, N,N,N′,N′-tetramethylethylenediamine, triphenylphosphine, tri-o-tolylphosphine, tricyclohexylphosphine, tributylphosphine, triethylphosphine, 2,2′-bis(diphenylphosphino)-1,1′-binaphthyl, 1,3-bis(2,6-diisopropylphenyl)imidazol-2-ylidene, 1,3-bis(mesityl)imidazol-2-ylidene, 1,1′-bis(diphenylphosphino)ferrocene, 1,2-bis(diphenylphosphino)ethane, N-methylimidazole, 2,2′-bipyridine, (bicyclo[2.2.1]hepta-2,5-diene), bis(di-tert-butyl(4-dimethylaminophenyl)phosphine), bis(tert-butyl isocyanide), 2-methoxyethyl ether, ethylene glycol dimethyl ether, 1,2-dimethoxyethane, bis(1,3-diamino-2-propanol), bis(N,N-diethylethylenediamine), 1,2-diaminocyclohexane, pyridine, 2,2′:6′,2″-terpyridine, diethyl sulfide, ethylene and amine complexes thereof; rhodium chloride, rhodium bromide, rhodium iodide, rhodium fluoride, rhodium hydride, rhodium oxide, rhodium peroxide, rhodium cyanide, rhodium sulfate, rhodium nitrate, rhodium phosphide, rhodium boride, rhodium chromium oxide, rhodium cobalt oxide, rhodium carbonate hydroxide, rhodium cyclohexane butyrate, rhodium hydroxide, rhodium molybdate, rhodium octanoate, rhodium oxalate, rhodium perchlorate, rhodium phthalocyanine, rhodium 5,9,14,18,23,27,32,36-octabutoxy-2,3-naphthalocyanine, rhodium sulfamate, rhodium perchlorate, rhodium thiocyanate, rhodium bis(2,2,6,6-tetramethyl-3,5-heptanedionate), rhodium propionate, rhodium acetate, rhodium stearate, rhodium 2-ethylhexanoate, rhodium acetylacetonate, rhodium hexafluoroacetylacetonate, rhodium tetrafluoroborate, rhodium thiosulfate, rhodium trifluoroacetate, rhodium phthalocyaninetetrasulfonic acid tetrasodium salt, rhodium methyl, rhodium cyclopentadienyl, rhodium methylcyclopentadienyl, rhodium ethylcyclopentadienyl, rhodium pentamethylcyclopentadienyl, rhodium 2,3,7,8,12,13,17,18-octaethyl-21H,23H-porphine, rhodium 5,10,15,20-tetraphenyl-21H,23H-porphine, rhodium bis(5-[[4-(dimethylamino)phenyl]imino]-8(5H)-quinolinone), rhodium 2,11,20,29-tetra-tert-butyl-2,3-naphthalocyanine, rhodium 2,9,16,23-tetraphenoxy-29H,31H-phthalocyanine, rhodium 5,10,15,20-tetrakis(pentafluorophenyl)-21H,23H-porphine and the 1,4-bis(diphenylphosphine)butane, 1,3-bis(diphenylphosphino)propane, 2-(2′-di-tert-butylphosphine)biphenyl, acetonitrile, benzonitrile, ethylenediamine, chloroform, 1,2-bis(phenylsulfinyl)ethane, 1,3-bis(2,6-diisopropylphenyl)imidazolidene)(3-chloropyridyl), 2′-(dimethylamino)-2-biphenylyl, dinorbornylphosphine, 2-(dimethylaminomethyl)ferrocene, allyl, bis(diphenylphosphino)butane, (N-succinimidyl)bis(triphenylphosphine), dimethylphenylphosphine, methyldiphenylphosphine, 1,10-phenanthroline, 1,5-cyclooctadiene, N,N,N′,N′-tetramethylethylenediamine, triphenylphosphine, tri-o-tolylphosphine, tricyclohexylphosphine, tributylphosphine, triethylphosphine, 2,2′-bis(diphenylphosphino)-1,1′-binaphthyl, 1,3-bis(2,6-diisopropylphenyl)imidazol-2-ylidene, 1,3-bis(mesityl)imidazol-2-ylidene, 1,1′-bis(diphenylphosphino)ferrocene, 1,2-bis(diphenylphosphino)ethane, N-methylimidazole, 2,2′-bipyridine, (bicyclo[2.2.1]hepta-2,5-diene), bis(di-tert-butyl(4-dimethylaminophenyl)phosphine), bis(tert-butyl isocyanide), 2-methoxyethyl ether, ethylene glycol dimethyl ether, 1,2-dimethoxyethane, bis(1,3-diamino-2-propanol), bis(N,N-diethylethylenediamine), 1,2-diaminocyclohexane, pyridine, 2,2′:6′,2″-terpyridine, diethyl sulfide, ethylene and amine complexes thereof; potassium hexachloropalladate(IV), sodium hexachloropalladate(IV), ammonium hexachloropalladate(IV), potassium tetrachloropalladate(II), sodium tetrachloropalladate(II), ammonium tetrachloropalladate(II), bromo(tri-tert-butylphosphine)palladium(I) dimer, (2-methylallyl)palladium(II) chloride dimer, bis(dibenzylideneacetone)palladium(0), tris(dibenzylideneacetone)dipalladium(0), tetrakis(triphenylphosphine)palladium(0), tetrakis(tricyclohexylphosphine)palladium(0), bis[1,2-bis(diphenylphosphine)ethane]palladium(0), bis(3,5,3′,5′-dimethoxydibenzylideneacetone)palladium(0), bis(tri-tert-butylphosphine)palladium(0), meso-tetraphenyltetrabenzoporphinepalladium, tetrakis(methyldiphenylphosphine)palladium(0), tris(3,3′,3″-phosphinidynetris(benzenesulfonato)palladium(0) nonasodium salt, 1,3-bis(2,4,6-trimethylphenyl)imidazol-2-ylidene(1,4-naphthoquinone)palladium(0), 1,3-bis(2,6-diisopropylphenyl)imidazol-2-ylidene(1,4-naphthoquinone)palladium(0) and the chloroform complex thereof; allylnickel(II) chloride dimer, ammoniumnickel(II) sulfate, bis(1,5-cyclooctadiene)nickel(0), bis(triphenylphosphine)dicarbonylnickel(0), tetrakis(triphenylphosphine)nickel(0), tetrakis(triphenyl phosphite)nickel(0), potassium hexafluoronickelate(IV), potassium tetracyanonickelate(II), potassium nickel(IV) paraperiodate, dilithium tetrabromonickelate(II), potassium tetracyanonickelate(II); platinum(IV) chloride, platinum(IV) oxide, platinum(IV) sulfide, potassium hexachloroplatinate(IV), sodium hexachloroplatinate(IV), ammonium hexachloroplatinate(IV), potassium tetrachloroplatinate(II), ammonium tetrachloroplatinate(II), potassium tetracyanoplatinate(II), trimethyl(methylcyclopentadienyl)platinum(IV), cis-diammintetrachloroplatinum(IV), potassium trichloro(ethylene)platinate(II), sodium hexahydroxyplatinate(IV), tetraamineplatinum(II) tetrachloroplatinate(II), tetrabutylammonium hexachloroplatinate(IV), ethylenebis(triphenylphosphine)platinum(0), platinum(0) 1,3-divinyl-1,1,3,3-tetramethyldisiloxane, platinum(0) 2,4,6,8-tetramethyl-2,4,6,8-tetravinylcyclotetrasiloxane, tetrakis(triphenylphosphine)platinum(0), platinum octaethylporphyrine, chloroplatinic acid, carboplatin; chlorobis(ethylene)rhodium dimer, hexarhodium hexadecacarbonyl, chloro(1,5-cyclooctadiene)rhodium dimer, chloro(norbornadiene)rhodium dimer, chloro(1,5-hexadiene)rhodium dimer.

The ligands preferably comprise phosphines of the formula (VIII)

PR⁸₃ (VIII)

where the R⁸ radicals are each independently hydrogen, straight-chain, branched or cyclic C₁-C₂₀-alkyl, C₁-C₂₀-alkylaryl, C₂-C₂₀-alkenyl, C₂-C₂₀-alkynyl, C₁-C₂₀-carboxylate, C₁-C₂₀-alkoxy, C₁-C₂₀-alkenyloxy, C₁-C₂₀-alkynyloxy, C₂-C₂₀-alkoxycarbonyl, C₁-C₂₀-alkylsulfonyl, C₁-C₂₀-alkylsulfinyl, silyl and/or their derivatives and/or phenyl substituted by at least one R⁹, or naphthyl substituted by at least one R⁹. R⁹ in each occurrence is independently hydrogen, fluorine, chlorine, bromine, iodine, NH₂, nitro, hydroxyl, cyano, formyl, straight-chain, branched or cyclic C₁-C₂₀-alkyl, C₁-C₂₀-alkoxy, HN(C₁-C₂₀-alkyl), N(C₁-C₂₀-alkyl)₂, —CO₂—(C₁-C₂₀-alkyl), —CON(C₁-C₂₀-alkyl)₂, —OCO(C₁-C₂₀-alkyl), NHCO(C₁-C₂₀-alkyl), C₁-C₂₀-Acyl, —SO₃M, —SO₂N(R¹⁰)M, —CO₂M, —PO₃M₂, -AsO₃M₂, —SiO₂M, —C(CF₃)₂OM (M=H, Li, Na or K), where R¹⁰ is hydrogen, fluorine, chlorine, bromine, iodine, straight-chain, branched or cyclic C₁-C₂₀-alkyl, C₂-C₂₀-alkenyl, C₂-C₂₀-alkynyl, C₁-C₂₀-carboxylate, C₁-C₂₀-alkoxy, C₁-C₂₀-alkenyloxy, C₁-C₂₀-alkynyloxy, C₂-C₂₀-alkoxycarbonyl, C₁-C₂₀-alkylthio, C₁-C₂₀-alkylsulfonyl, C₁-C₂₀-alkylsulfinyl, silyl and/or their derivatives, aryl, C₁-C₂₀-arylalkyl, C₁-C₂₀-alkylaryl, phenyl and/or biphenyl. Preferably, the R⁸ groups are all identical.

Suitable phosphines(VIII) are for example trimethylphosphine, triethylphosphine, tripropylphosphine, triisopropylphosphine, tributylphosphine, triisobutylphosphine, triisopentylphosphine, trihexylphosphine, tricyclohexylphosphine, trioctylphosphine, tridecylphosphine, triphenylphosphine, diphenylmethylphosphine, phenyldimethylphosphine, tri(o-tolyl)phosphine, tri(ptolyl)phosphine, ethyldiphenylphosphine, dicyclohexylphenylphosphine, 2-pyridyldiphenylphosphine, bis(6-methyl-2-pyridyl)phenylphosphine, tri(p-chlorophenyl)phosphine, tri(p-methoxyphenyl)phosphine, diphenyl(2-sulfonatophenyl)phosphine; potassium, sodium and ammonium salts of diphenyl(3-sulfonatophenyl)phosphine, bis(4,6-dimethyl-3-sulfonatophenyl)(2,4-dimethylphenyl)phosphine, bis(3-sulfonatophenyl)phenylphosphines, tris(4,6-dimethyl-3-sulfonatophenyl)phosphines, tris(2-sulfonatophenyl)phosphines, tris(3-sulfonatophenyl)phosphines; 2-bis(diphenylphosphinoethyl)trimethylammonium iodide, 2′-dicyclohexylphosphino-2,6-dimethoxy-3-sulfonato-1,1′-biphenyl sodium salt, trimethyl phosphite and/or triphenyl phosphite.

The ligands more preferably comprise bidentate ligands of the general formula

R⁸₂M″-Z-M″R⁸₂ (IX).

In this formula, each M″ independently is N, P, As or Sb.

M″ is preferably the same in the two occurrences and more preferably is a phosphorus atom.

Each R⁸ group independently represents the radicals described under formula (VIII). The R⁸ groups are preferably all identical.

Z is preferably a bivalent bridging group which contains at least 1 bridging atom, preferably from 2 to 6 bridging atoms.

Bridging atoms can be selected from carbon, nitrogen, oxygen, silicon and sulfur atoms. Z is preferably an organic bridging group containing at least one carbon atom. Z is preferably an organic bridging group containing 1 to 6 bridging atoms, of which at least two are carbon atoms, which may be substituted or unsubstituted.

Preferred Z groups are —CH₂—, —CH₂—CH₂—, —CH₂—CH₂—CH₂—, —CH₂—CH(CH₃)—CH₂—, —CH₂—C(CH₃)₂—CH₂—, —CH₂—C(C₂H₅)—CH₂—, —CH₂—Si(CH₃)₂—CH₂—, —CH₂—CH₂—CH₂—CH₂—, —CH₂—CH(C₂H₅)—CH₂—, —CH₂—CH(n-Pr)—CH and —CH₂—CH(n-Bu)—CH₂—, substituted or unsubstituted 1,2-phenyl, 1,2-cyclohexyl, 1 or 1,2-ferrocenyl radicals, 2,2″-(1,1″-biphenyl), 4,5-xanthene and/or oxydi-2,1-phenylene radicals.

Examples of suitable bidentate phosphine ligands (IX) are for example 1,2-bis(dimethylphosphino)ethane, 1,2-bis(diethylphosphino)ethane, 1,2-bis(dipropylphosphino)ethane, 1,2-bis(diisopropylphosphino)ethane, 1,2-bis(dibutylphosphino)ethane, 1,2-bis(di-tert-butylphosphino)ethane, bis(dicyclohexylphosphino)ethane, 1,2-bis(diphenylphosphino)ethane; 1,3-bis(dicyclohexylphosphino)propane, 1,3-bis(diisopropylphosphino)propane, 1,3-bis(di-tert-butylphosphino)propane, 1,3-bis(diphenylphosphino)propane; 1,4-bis(diisopropylphosphino)butane, 1,4-bis(diphenylphosphino)butane; 1,5-bis(dicyclohexylphosphino)pentane, 1,2-bis(di-tert-butylphosphino)benzene, 1,2-bis(diphenylphosphino)benzene, 1,2-bis(dicyclohexylphosphino)benzene, 1,2-bis(dicyclopentylphosphino)benzene, 1,3-bis(di-tert-butylphosphino)benzene, 1,3-bis(diphenylphosphino)benzene, 1,3-bis(dicyclohexylphosphino)benzene, 1,3-bis(dicyclopentylphosphino)benzene; 9,9-dimethyl-4,5-bis(diphenylphosphino)xanthene, 9,9-dimethyl-4,5-bis(diphenylphosphino)-2,7-di-tert-butylxanthene, 9,9-dimethyl-4,5-bis(di-tert-butylphosphino)xanthene, 1,1′-bis(diphenylphosphino)ferrocene, 2,2′-bis(diphenylphosphino)-1,1′-binaphthyl, 2,2′-bis(di-ptolylphosphino)-1,1′-binaphthyl, (oxydi-2,1-phenylene)bis(diphenylphosphine), 2,5-(diisopropylphospholano)benzene, 2,3-O-isopropropylidene-2,3-dihydroxy-1,4-bis(diphenylphosphino)butane, 2,2′-bis(di-tert-butylphosphino)-1,1-biphenyl, 2,2′-bis(dicyclohexylphosphino)-1,1′-biphenyl, 2,2′-bis(diphenylphosphino)-1,1′-biphenyl, 2-(di-tert-butylphosphino)-2′-(N,N-dimethylamino)biphenyl, 2-(dicyclohexylphosphino)-2′-(N,N-dimethylamino)biphenyl, 2-(diphenylphosphino)-2′-(N,N-dimethylamino)biphenyl, 2-(diphenylphosphino)ethylamine, 2-[2-(diphenylphosphino)ethyl]pyridine; potassium, sodium and ammonium salts of 1,2-bis(di-4-sulfonatophenylphosphino)benzene, (2,2′-bis[[bis(3-sulfonatophenyl)phosphino]methyl]-4,4′,7,7′-tetrasulfonato-1,1′-binapthyl, (2,2′-bis[[bis(3-sulfonatophenyl)phosphino]methyl]-5,5′-tetrasulfonato-1,1′-biphenyl, (2,2′-bis[[bis(3-sulfonatophenyl)phosphino]methyl]-1,1′-binapthyl, (2,2′-bis[[bis(3-sulfonatophenyl)phosphino]methyl]-1,1′-biphenyl, 9,9-dimethyl-4,5-bis(diphenylphosphino)-2,7-sulfonatoxanthene, 9,9-dimethyl-4,5-bis(di-tert-butylphosphino)-2,7-sulfonatoxanthene, 1,2-bis(di-4-sulfonatophenylphosphino)benzene, meso-tetrakis(4-sulfonatophenyl)porphine, meso-tetrakis(2,6-dichloro-3-sulfonatophenyl)porphine, meso-tetrakis(3-sulfonatomesityl)porphine, tetrakis(4-carboxyphenyl)porphine and 5,11,17,23-sulfonato-25,26,27,28-tetrahydroxycalix[4]arene.

Moreover, the ligands of the formula (VIII) and (IX) can be attached to a suitable polymer or inorganic substrate by the R⁸ radicals and/or the bridging group.

The molar transition metal/ligand ratio of the catalyst system is in the range 1:0.01 to 1:100, preferably in the range from 1:0.05 to 1:10 and more preferably in the range from 1:1 to 1:4.

The reactions in the process stages a), b) c), d) and e) preferably take place, if desired, in an atmosphere comprising further gaseous constituents such as nitrogen, oxygen, argon, carbon dioxide for example; the temperature is in the range from −20 to 340° C., more particularly in the range from 20 to 180° C., and total pressure is in the range from 1 to 100 bar.

The products and/or the transition metal and/or the transition metal compound and/or catalyst system and/or the ligand and/or starting materials are optionally isolated after the process stages a), b) c), d) and e) by distillation or rectification, by crystallization or precipitation, by filtration or centrifugation, by adsorption or chromatography or other known methods.

According to the present invention, solvents, auxiliaries and any other volatile constituents are removed by distillation, filtration and/or extraction for example.

The reactions in the process stages a), b) c), d) and e) are preferably carried out, if desired, in absorption columns, spray towers, bubble columns, stirred tanks, trickle bed reactors, flow tubes, loop reactors and/or kneaders.

Suitable mixing elements include for example anchor, blade, MIG, propeller, impeller and turbine stirrers, cross beaters, disperser disks, hollow (sparging) stirrers, rotor-stator mixers, static mixers, Venturi nozzles and/or mammoth pumps.

The intensity of mixing experienced by the reaction solutions/mixtures preferably corresponds to a rotation Reynolds number in the range from 1 to 1 000 000 and preferably in the range from 100 to 100 000.

It is preferable for an intensive commixing of the respective reactants etc. to be effected by an energy input in the range from 0.080 to 10 kW/m³, preferably 0.30-1.65 kW/m³.

During the reaction, the particular catalyst A, B or C is preferably homogeneous and/or heterogeneous in action. Therefore, the particular heterogeneous catalyst is effective during the reaction as a suspension or bound to a solid phase.

Preferably, the particular catalyst A, B or C is generated in situ before the reaction and/or at the start of the reaction and/or during the reaction.

Preferably, the particular reaction takes place in a solvent as a single-phase system in homogeneous or heterogeneous mixture and/or in the gas phase.

When a multi-phase system is used, a phase transfer catalyst may be used in addition.

The reactions of the present invention can be carried out in liquid phase, in the gas phase or else in supercritical phase. The particular catalyst A, B or C is preferably used in the case of liquids in homogeneous form or as a suspension, while a fixed bed arrangement is advantageous in the case of gas phase or supercritical operation.

Suitable solvents are water, alcohols, e.g. methanol, ethanol, isopropanol, npropanol, n-butanol, isobutanol, tert-butanol, n-amyl alcohol, isoamyl alcohol, tert-amyl alcohol, n-hexanol, n-octanol, isooctanol, n-tridecanol, benzyl alcohol, etc. Preference is further given to glycols, e.g. ethylene glycol, 1,2-propanediol, 1,3-propanediol, 1,3-butanediol, 1,4-butanediol, diethylene glycol etc.; aliphatic hydrocarbons, such as pentane, hexane, heptane, octane, and petroleum ether, naphtha, kerosene, petroleum, paraffin oil, etc.; aromatic hydrocarbons, such as benzene, toluene, xylene, mesitylene, ethylbenzene, diethylbenzene, etc.; halogenated hydrocarbons, such as methylene chloride, chloroform, 1,2-dichloroethane, chlorobenzene, carbon tetrachloride, tetrabromoethylene, etc.; alicyclic hydrocarbons, such as cyclopentane, cyclohexane, and methylcyclohexane, etc.; ethers, such as anisole (methyl phenyl ether), tert-butyl methyl ether, dibenzyl ether, diethyl ether, dioxane, diphenyl ether, methyl vinyl ether, tetrahydrofuran, triisopropyl ether etc.; glycol ethers, such as diethylene glycol diethyl ether, diethylene glycol dimethyl ether (diglyme), diethylene glycol monobutyl ether, diethylene glycol monomethyl ether, 1,2-dimethoxyethane (DME, monoglyme), ethylene glycol monobutyl ether, triethylene glycol dimethyl ether (triglyme), triethylene glycol monomethyl ether etc.; ketones, such as acetone, diisobutyl ketone, methyl n-propyl ketone; methyl ethyl ketone, methyl isobutyl ketone etc.; esters, such as methyl formate, methyl acetate, ethyl acetate, n-propyl acetate, and n-butyl acetate, etc.; carboxylic acids, such as formic acid, acetic acid, propionic acid, butyric acid, etc. One or more of these compounds can be used, alone or in combination.

Suitable solvents also encompass the phosphinic acid sources and olefins used. These have advantages in the form of higher space-time yield.

It is preferable that the reaction be carried out under the autogenous vapor pressure of the olefin and/or of the solvent.

Preferably, R¹, R², R³ and R⁴ of olefin (IV) are the same or different and each is independently H, methyl, ethyl, n-propyl, isopropyl, n-butyl, isobutyl, tert-butyl and/or phenyl.

Preference is also given to using functionalized olefins such as allyl isothiocyanate, allyl methacrylate, 2-allylphenol, N-allylthiourea, 2-(allylthio)-2-thiazoline, allyltrimethylsillane, allyl acetate, allyl acetoacetate, allyl alcohol, allylamine, allylbenzene, allyl cyanide, allyl cyanoacetate, allylanisole, trans-2-pentenal, cis-2-pentenenitrile, 1-penten-3-ol, 4-penten-1-ol, 4-penten-2-ol, trans-2-hexenal, trans-2-hexen-1-ol, cis-3-hexen-1-ol, 5-hexen-1-ol, styrene, -methylstyrene, 4-methylstyrene, vinyl acetate, 9-vinylanthracene, 2-vinylpyridine, 4-vinylpyridine and 1-vinyl-2-pyrrolidone.

The partial pressure of the olefin during the reaction is preferably 0.01-100 bar and more preferably 0.1-10 bar.

The phosphinic acid/olefin molar ratio for the reaction is preferably in the range from 1:10 000 to 1:0.001 and more preferably in the range from 1:30 to 1:0.01.

The phosphinic acid/catalyst molar ratio for the reaction is preferably in the range from 1:1 to 1:0.00000001 and more preferably in the range from 1:0.01 to 1:0.000001.

The phosphinic acid/solvent molar ratio for the reaction is preferably in the range from 1:10 000 to 1:0 and more preferably in the range from 1:50 to 1:1.

One method the present invention provides for producing compounds of the formula (II) comprises reacting a phosphinic acid source with olefins in the presence of a catalyst and freeing the product (II) (alkylphosphonous acid, salts or esters) of catalyst, transition metal or transition metal compound as the case may be, ligand, complexing agent, salts and by-products.

The present invention provides that the catalyst, the catalyst system, the transition metal and/or the transition metal compound are separated off by adding an auxiliary 1 and removing the catalyst, the catalyst system, the transition metal and/or the transition metal compound by extraction and/or filtration.

The present invention provides that the ligand and/or complexing agent is separated off by extraction with auxiliary 2 and/or distillation with auxiliary 2.

Auxiliary 1 is preferably water and/or at least one member of the group of metal scavengers. Preferred metal scavengers are metal oxides, such as aluminum oxide, silicon dioxide, titanium dioxide, zirconium dioxide, zinc oxide, nickel oxide, vanadium oxide, chromium oxide, magnesium oxide, Celite®, kieselguhr; metal carbonates, such as barium carbonate, calcium carbonate, strontium carbonate; metal sulfates, such as barium sulfate, calcium sulfate, strontium sulfate; metal phosphates, such as aluminum phosphate, vanadium phosphate, metal carbides, such as silicone carbide; metal aluminates, such as calcium aluminate; metal silicates, such as aluminum silicate, chalks, zeolites, bentonite, montmorillonite, hectorite; functionalized silicates, functionalized silica gels, such as SiliaBond®, QuadraSil™; functionalized polysiloxanes, such as Deloxan®; metal nitrides, carbon, activated carbon, mullite, bauxite, antimonite, scheelite, perovskite, hydrotalcite, functionalized and unfunctionalized cellulose, chitosan, keratin, heteropolyanions, ion exchangers, such as Amberlite™, Amberjet™, Ambersep™, Dowex®, Lewatit®, ScavNet®; functionalized polymers, such as Chelex®, QuadraPure™, Smopex®, PolyOrgs®; polymer-bound phosphanes, phosphane oxides, phosphinates, phosphonates, phosphates, amines, ammonium salts, amides, thioamides, urea, thioureas, triazines, imidazoles, pyrazoles, pyridines, pyrimidines, pyrazines, thiols, thiol ethers, thiol esters, alcohols, alkoxides, ethers, esters, carboxylic acids, acetates, acetals, peptides, hetarenes, polyethyleneimine/silicon dioxide, and/or dendrimers.

It is preferable that the amounts added of auxiliary 1 correspond to 0.1-40% by weight loading of the metal on auxiliary 1.

It is preferable that auxiliary 1 be used at temperatures of from 20 to 90° C.

It is preferable that the residence time of auxiliary 1 be from 0.5 to 360 minutes.

Auxiliary 2 is preferably the aforementioned solvent of the present invention as are preferably used in process stage a).

The esterification of the monocarboxy-functionalized dialkylphosphinic acid (III) or of the monofunctionalized dialkylphosphinic acid (VII) or of the monofunctionalized dialkylphosphinic acid (VI) or of the alkylphosphonous acid derivatives (II) and also of the phosphinic acid source (I) to form the corresponding esters can be achieved for example by reaction with higher-boiling alcohols by removing the resultant water by azeotropic distillation, or by reaction with epoxides (alkylene oxides).

Preferably, following step a), the alkylphosphonous acid (II) is directly esterified with an alcohol of the general formula M-OH and/or M′-OH or by reaction with E alkylene oxides, as indicated hereinbelow.

M-OH preferably comprises primary, secondary or tertiary alcohols having a carbon chain length of C₁-C₁₈. Particular preference is given to methanol, ethanol, propanol, isopropanol, n-butanol, 2-butanol, tert-butanol, amyl alcohol and/or hexanol.

M′-OH preferably comprises ethylene glycol, 1,2-propylene glycol, 1,3-propylene glycol, 1,4-butanediol, 2,2-dimethylpropane-1,3-diol, neopentyl glycol, 1,6-hexanediol, 1,4-cyclohexanedimethanol, glycerol, trishydroxymethylethane, trishydroxymethylpropane, pentaerythritol, sorbitol, mannitol, α-naphthol, polyethylene glycols, polypropylene glycols and/or EO-PO block polymers.

Also useful as M-OH and M′-OH are mono- or polyhydric unsaturated alcohols having a carbon chain length of C₁-C₁₈, for example n-but-2-en-1-ol, 1,4-butenediol and allyl alcohol.

Also useful as M-OH and M′-OH are reaction products of monohydric alcohols with one or more molecules of alkylene oxides, preferably with ethylene oxide and/or 1,2-propylene oxide. Preference is given to 2-methoxyethanol, 2-ethoxyethanol, 2-n-butoxyethanol, 2-(2′-ethylhexyloxy)ethanol, 2-n-dodecoxyethanol, methyl diglycol, ethyl diglycol, isopropyl diglycol, fatty alcohol polyglycol ethers and aryl polyglycol ethers.

M-OH and M′-OH are also preferably reaction products of polyhydric alcohols with one or more molecules of alkylene oxide, more particularly diglycol and triglycol and also adducts of 1 to 6 molecules of ethylene oxide or propylene oxide onto glycerol, trishydroxymethylpropane or pentaerythritol.

Useful M-OH and M′-OH further include reaction products of water with one or more molecules of alkylene oxide. Preference is given to polyethylene glycols and poly-1,2-propylene glycols of various molecular sizes having an average molecular weight of 100-1000 g/mol and more preferably of 150-350 g/mol.

Preference for use as M-OH and M′-OH is also given to reaction products of ethylene oxide with poly-1,2-propylene glycols or fatty alcohol propylene glycols; similarly reaction products of 1,2-propylene oxide with polyethylene glycols or fatty alcohol ethoxylates. Preference is given to such reaction products with an average molecular weight of 100-1000 g/mol, more preferably of 150-450 g/mol.

Also useful as M-OH and M′-OH are reaction products of alkylene oxides with ammonia, primary or secondary amines, hydrogen sulfide, mercaptans, oxygen acids of phosphorus and C₂-C₆ dicarboxylic acids. Suitable reaction products of ethylene oxide with nitrogen compounds are triethanolamine, methyldiethanolamine, n-butyldiethanolamine, n-dodecyldiethanolamine, dimethylethanolamine, n-butylmethylethanolamine, di-n-butylethanolamine, n-dodecylmethylethanolamine, tetrahydroxyethylethylenediamine or pentahydroxyethyldiethylenetriamine.

Preferred alkylene oxides are ethylene oxide, 1,2-propylene oxide, 1,2-epoxybutane, 1,2-epoxyethylbenzene, (2,3-epoxypropyl)benzene, 2,3-epoxy-1-propanol and 3,4-epoxy-1-butene.

Suitable solvents are the solvents mentioned in process step a) and also the M-OH and M′-OH alcohols used and the alkylene oxides. These offer advantages in the form of a higher space-time yield.

The reaction is preferably carried out under the autogenous vapor pressure of the employed alcohol M-OH, M′-OH and alkylene oxide and/or of the solvent.

Preferably, the reaction is carried out at a partial pressure of the employed alcohol M-OH, M′-OH and alkylene oxide of 0.01-100 bar, more preferably at a partial pressure of the alcohol of 0.1-10 bar.

The reaction is preferably carried out at a temperature in the range from −20 to 340° C. and is more preferably carried out at a temperature in the range from 20 to 180° C.

The reaction is preferably carried out at a total pressure in the range from 1 to 100 bar.

The reaction is preferably carried out in a molar ratio for the alcohol or alkylene oxide component to the phosphinic acid source (I) or alkylphosphonous acid (II) or monofunctionalized dialkylphosphinic acid (VI) or monofunctionalized dialkylphosphinic acid (VII) or monocarboxy-functionalized dialkylphosphinic acid (III) ranging from 10 000:1 to 0.001:1 and more preferably from 1000:1 to 0.01:1.

The reaction is preferably carried out in a molar ratio for the phosphinic acid source (I) or alkylphosphonous acid (II) or monofunctionalized dialkylphosphinic acid (VI) or monofunctionalized dialkylphosphinic acid (VII) or monocarboxyfunctionalized dialkylphosphinic acid (III) to the solvent ranging from 1:10 000 to 1:0 and more preferably in a phosphinic acid/solvent molar ratio ranging from 1:50 to 1:1.

The catalysat B as used for process step b) for the reaction of the alkylphosphonous acid, salts or esters (II) with an acetylenic compound (V) to form the monofunctionalized dialkylphosphinic acid, salts and esters (VI) may preferably be the catalyst A.

Preferably, R⁵ and R⁶ in the acetylenic compounds of formula (V) are independent of each other and each represent H and/or C₁-C₆-alkyl, C₆-C₁₈-aryl and/or C₇-C₂₀-alkylaryl (substituted or unsubstituted).

Preferably, R⁵ and R⁶ are each H, methyl, ethyl, propyl, i-propyl, n-butyl, i-butyl, t-butyl, n-pentyl, i-pentyl, n-hexyl, i-hexyl, phenyl, naphthyl, tolyl, 2-phenylethyl, 1-phenylethyl, 3-phenylpropyl and/or 2-phenylpropyl.

Preference for use as acetylenic compounds is given to acetylene, methylacetylene, 1-butyne, 1-hexyne, 2-hexyne, 1-octyne, 4-octyne, 1-butyn-4-ol, 2-butyn-1-ol, 3-butyn-1-ol, 5-hexyn-1-ol, 1-octyn-3-ol, 1-pentyne, phenylacetylene and/or trimethylsilylacetylene.

The reaction is preferably carried out in the presence of a phosphinic acid of formula (X)

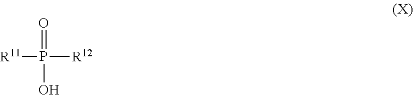

where R¹¹ and R¹² are each independently C₂-C₂₀-alkyl, C₂-C₂₀-aryl or C₈-C₂₀-alkaryl, substituted or unsubstituted.

Preferably, R¹¹ and R¹² are each independently methyl, ethyl, n-propyl, i-propyl, n-butyl, i-butyl, s-butyl, t-butyl, n-pentyl, n-hexyl, phenyl, naphthyl, tolyl or xylyl (substituted or unsubstituted).

Preferably, the proportion of phosphinic acid (X) based on the alkylphosphonous acid (II) used is in the range from 0.01 to 100 mol % and more particularly in the range from 0.1 to 10 mol %.

The reaction is preferably carried out at temperatures of 30 to 120° C. and more preferably at 50 to 90° C.; the reaction time is in the range from 0.1 to 20 hours.

The reaction is preferably carried out under the autogenous vapor pressure of the acetylenic compound (V) and/or of the solvent.

Suitable solvents for process stage b) are those used above in process stage a).

The reaction is preferably carried out at a partial pressure of the acetylenic compound from 0.01-100 bar, more preferably at 0.1-10 bar.

The ratio of acetylenic compound (V) to alkylphosphonous acid (II) is preferably in the range from 10 000:1 to 0.001:1 and more preferably in the range from 30:1 to 0.01:1.

The reaction is preferably carried out in an alkylphosphonous acid/catalyst molar ratio of 1:1 to 1:0.00000001 and more preferably in an alkylphosphonous acid/catalyst molar ratio of 1:0.25 to 1:0.000001.

The reaction is preferably carried out in an alkylphosphonous acid/solvent molar ratio of 1:10 000 to 1:0 and more preferably in an alkylphosphonous acid/solvent molar ratio of 1:50 to 1:1.

The reaction described in step c) is achieved by hydrocyanation of the monofunctionalized dialkylphosphinic acid (VI) with hydrogen cyanide or a hydrogen cyanide source in the presence of a catalyst C.

The catalyst C as used for process step c) for the reaction of the monofunctionalized dialkylphosphinic acid derivative (VI) with a hydrogen cyanide or hydrogen cyanide source to form the monofunctionalized dialkylphosphinic acid derivative VII may preferably be the catalyst A, or is derived from a metal of the first transition group.

The transition metal for catalyst C preferably comprises palladium, copper or nickel.

In addition to the sources of transition metals and transition metal compounds that were listed under catalyst A it is also possible to use the following transition metals and transition metal compounds:

copper, copper-tin alloy, copper-zinc alloy, silver-copper alloy, titanium-copper alloy, Raney® copper, copper zinc iron oxide, copper aluminum oxide, copper iron oxide, copper chromite, copper(I) and/or copper(II) chloride, bromide, iodide, fluoride, oxide, hydroxide, cyanide, sulfide, telluride, hydride, sulfate, nitrate, propionate, acetate, acetylacetonate, hexafluoroacetylacetonate, 2-ethylhexanoate, 3,5-diisopropylsalicylate, carbonate, methoxide, tartrate, cyclohexanebutyrate, D-gluconate, formate, molybdate, niobate, phthalocyanine, pyrophosphate, cyclopentadienyl, methylcyclopentadienyl, ethylcyclopentadienyl, pentamethylcyclopentadienyl, N,N′-diisopropylacetamidinate, thiophene-2-carboxylate, thiocyanate, thiophenoxide, trifluoromethanesulfonate, hexafluorophosphate, tetrafluoroborate, triflate, 1-butanethiolate, 2,2,6,6-tetramethyl-3,5-heptanedionate, thiosulfate, trifluoroacetate, perchlorate, 2,3,7,8,12,13,17,18-octaethyl-21H,23H-porphine, 5,10,15,20-tetraphenyl-21H,23H-porphine, 5,10,15,20-tetrakis(pentafluoro-phenyl)-21H,23H-porphine and their 1,4-bis(diphenylphosphine)butane, 1,3-bis(diphenylphosphino)propane, 2-(2′-di-tert-butylphosphine)biphenyl, acetonitrile, benzonitrile, ethylenediamine, dinorbornylphosphine, bis(diphenylphosphino)butane, (Nsuccinimidyl)bis(triphenylphosphine), dimethylphenylphosphine, methyldiphenylphosphine, 1,10-phenanthroline, 1,5-cyclooctadiene, N,N,N′,N′-tetramethylethylenediamine, triphenylphosphine, tri-o-tolylphosphine, tricyclohexylphosphine, triethylphosphine, 2,2′-bis(diphenylphosphino)-1,1′-binaphthyl, 1,3-bis(2,6-diisopropylphenyl)imidazol-2-ylidene, 1,3-bis(mesityl)imidazol-2-ylidene, 1,1′-bis(diphenylphosphino)ferrocene, 1,2-bis(diphenylphosphino)ethane, 2,2′-bipyridine, bis(di-tert-butyl(4-dimethylaminophenyl)phosphine), trimethyl phosphite, ethylenediamine, bis(trimethylsilyl)acetylene, and amine complexes, copper naphthenate, copper oxychloride, ammonium tetrachlorocuprate(II).

In addition to the ligands listed under catalyst A, the following compounds can also be used:

diphenyl p-, m- or o-tolyl phosphite, di-p-, -m- or -o-tolyl phenyl phosphite, m-tolyl o-tolyl p-tolyl phosphite, o-tolyl p- or m-tolyl phenyl phosphite, di-p-tolyl m- or o-tolyl phosphite, di-m-tolyl p- or o-tolyl phosphite, tri-m-, -p- or -o-tolyl phosphite, di-o-tolyl m- or p-tolyl phosphite; tris(2-ethylhexyl)phosphite, tribenzyl phosphite, trilauryl phosphite, tri-n-butyl phosphite, triethyl phosphite, tri-neopentyl phosphite, tri-1-propyl phosphite, tris(2,4-di-t-butylphenyl)phosphite, tris(2,4-di-tert-butylphenyl)phosphite, diethyl trimethylsilyl phosphite, diisodecyl phenyl phosphite, dimethyl trimethylsilyl phosphite, triisodecyl phosphite, tris(tert-butyldimethylsilyl)phosphite, tris(2-chloroethyl phosphite, tris(1,1,1,3,3,3-hexafluoro-2-propyl)phosphite, tris(nonylphenyl)phosphite, tris(2,2,2-trifluoroethyl)phosphite, tris(trimethylsilyl)phosphite, 2,2-dimethyltrimethylene phenyl phosphite, trioctadecyl phosphite, triimethylolpropane phosphite, benzyldiethyl phosphite, (R)-binaphthyl isobutyl phosphite, (R)-binaphthyl cyclopentyl phosphite, (R)-binaphthyl isopropyl phosphite, tris(2-tolyl)phosphite, tris(nonylphenyl)phosphite, methyl diphenyl phosphite; (11aR)-(+)-10,11,12,13-tetrahydrodiindeno[7,1-de:1′,7′-fg][1,3,2]dioxaaphosphocine-5-phenoxy, 4-ethyl-2,6,7-trioxa-1-phosphabicyclo[2.2.2]octane, (11bR,11′bR)-4,4′-(9,9-dimethyl-9H-xanthene-4,5-diyl)bisdinaphtho[2,1-d:1′,2′-f][1,3,2]dioxaphosphepine, (11bR,11′bR)-4,4′-(oxydi-2,1-phenylene)bisdinaphtho[2,1-d:, 1′,2′-f][1,3,2]dioxaphosphepine, (11bS,11′bS)-4,4′-(9,9-dimethyl-9H-xanthene-4,5-diyl)bisdinaphtho[2,1-d:1′,2′-f][1,3,2]dioxaphosphepine, (11bS,11′bS)-4,4′-(oxydi-2,1-phenylene)bisdinaphtho[2,1-d: 1′,2′-f][1,3,2]dioxaphosphepine, 1,1′-bis[(11bR)— and 1,1′-bis[(11bS)-dinaphtho[2,1-d:1′,2′-f][1,3,2]dioxaphosphepine-4-yl]ferrocene; dimethyl phenylphosphonite, diethyl methylphosphonite, diethyl phenylphosphonite, diisopropyl phenylphosphonite; methyl methylphenylphosphinite, isopropyl isopropylphenylphosphinite, ethyl diphenylphosphinite and methyl diphenylphosphinite.

In addition to the bidentate ligands listed under catalyst A, the following compounds can also be used:
1,2-bis(diadamantylphosphinomethyl)benzene, 1,2-bis(di-3,5-dimethyladamantylphosphinomethyl)benzene, 1,2-bis(di-5-tert-butyladamantaylphosphinomethyl)benzene, 1,2-bis(1-adamantyl tert-butylphosphinomethyl)benzene, 1-(di-tert-butylphosphinomethyl)benzene, 1-(diadamantylphosphinomethyl)-2-(phosphaadamantylphosphinomethyl)benzene, 1,2-bis(di-tert-butylphosphinomethyl)ferrocene, 1,2-bis(dicyclohexylphosphinomethyl)ferrocene, 1,2-bis(diisobutylphosphinomethyl)ferrocene, 1,2-bis(dicyclopentylphosphinomethyl)ferrocene, 1,2-bis(diethylphosphinomethyl)ferrocene, 1,2-bis(diisopropylphosphinomethyl)ferrocene, 1,2-bis(dimethylphosphinomethyl)ferrocene, 9,9-dimethyl-4,5-bis(diphenoxyphosphine)xanthene, 9,9-dimethyl-4,5-bis(di-pmethylphenoxyphosphine)xanthene, 9,9-dimethyl-4,5-bis(di-o-methylphenoxyphosphine)xanthene, 9,9-dimethyl-4,5-bis(di-1,3,5-trimethylphenoxyphosphine)xanthene, 9,9-dimethyl-4,5-bis(diphenoxyphosphine)-2,7-di-tert-butylxanthene, 9,9-dimethyl-4,5-bis(di-o-methylphenoxyphosphine)-2,7-di-tert-butylxanthene, 9,9-dimethyl-4,5-bis(di-p-methylphenoxyphosphine)-2,7-di-tert-butylxanthene, 9,9-dimethyl-4,5-bis(di-1,3,5-trimethylphenoxyphosphine)-2,7-di-tert-butylxanthene, 1,1′-bis(diphenoxyphosphine)ferrocene, 1,1′-bis(di-omethylphenoxy)ferrocene, 1,1′-bis(di-p-methylphenoxyphosphine)ferrocene, 1,1′-bis(di-1,3,5-trimethylphenoxyphosphine)ferrocene, 2,2′-bis(diphenoxyphosphine)-1,1′-binaphthyl, 2,2′-bis(di-o-methylphenoxyphosphine)-1,1′-binaphthyl, 2,2′-bis(di-p-methylphenoxyphosphine)-1,1′-binaphthyl, 2,2′-bis(di-1,3,5-trimethylphenoxyphosphine)-1,1′-binaphthyl, (oxydi-2,1-phenylene)bis(diphenoxyphosphine), (oxydi-2,1-phenylene)bis(di-o-methylphenoxyphosphine), (oxydi-2,1-phenylene)bis(di-p-methylphenoxyphosphine), (oxydi-2,1-phenylene)bis(di-1,3,5-trimethylphenoxyphosphine), 2,2′-bis(diphenoxyphosphine)-1,1′-biphenyl, 2,2′-bis(di-o-methylphenoxyphosphine)-1,1′-biphenyl, 2,2′-bis(di-p-methylphenoxyphosphine)-1,1′-biphenyl, 2,2′-bis(c-1′-1,3,5-trimethylphenoxyphosphine)-1,1′-biphenyl, 1,2-bis(di-(1,3,5,7-tetramethyl-6,9,10-trioxa-2-phosphaadamantylmethyl)ferrocene, 1-(tert-butoxycarbonyl)-(2S,4S)-2-[(diphenylphosphino)methyl]-4-(dibenzophospholyl)pyrrolidine, 1-(tert-butoxycarbonyl)-(2S,4S)-2-[(dibenzophospholyl)methyl]-4-(diphenylphosphino)pyrrolidine, 1-(tert-butoxycarbonyl)-(2S,4S)-4-(dibenzophospholyl)-2-[(dibenzophospholyl)methyl]-pyrrolidine, BINAPHOS, kelliphite, chiraphite, bis-3,4-diazophospholane; bis(phospholane) ligands, such as bis(2,5-trans-dialkylphospholane), bis(2,4-transdialkylphosphethane), 1,2-bis(phenoxyphosphine)ethane, 1,2-bis(3-methylphenoxyphosphine)ethane, 1,2-bis(2-methylphenoxyphosphine)ethane, 1,2-bis(1-methylphenoxyphosphine)ethane, 1,2-bis(1,3,5-trimethylphenoxyphosphine)ethan, 1,3-bis(phenoxyphosphine)propane, 1,3-bis(3-methylphenoxyphosphine)propane, 1,3-bis(2-methylphenoxyphosphine)propane, 1,3-bis(1-methylphenoxyphosphine)propane, 1,3-bis(1,3,5-trimethylphenoxyphosphine)propane, 1,4-bis(phenoxyphosphine)butane, 1,4-bis(3-methylphenoxyphosphine)butane, 1,4-bis(2-methylphenoxyphosphine)butane, 1,4-bis(1-methylphenoxyphosphine)butane, 1,4-bis(1,3,5-trimethylphenoxyphosphine)butane.

Particular preference is given to using phosphites and diphosphites as ligands of the transition metals.

It is particularly preferable to use the transition metals in their zerovalent state.

Transition metal salts may preferably be used as a catalyst in the presence of a reducing agent. Preferred reducing agents are boron hydrides, metal borohydrides, aluminum hydrides, metal aluminohydrides, metal alkyls, zinc, iron, aluminum, sodium and hydrogen.

The hydrocyanation reaction is preferably carried out in the presence of a promoter.

Lewis acid are preferred promoters.

Preferred Lewis acids among those mentioned include in particular metal salts, preferably metal halides, such as fluorides, chlorides, bromides, iodides; and sulfates, sulfonates, haloalkylsulfonates, perhaloalkylsulfonates, for example fluoroalkylsulfonates or perfluoroalkylsulfonates; haloacetates, perhaloacetates, carboxylates and phosphates such as for example PO₄³⁻, HPO₄²⁻, H₂PO₄⁻, CF₃COO⁻, C₇H₁₅OSO₂⁻ or SO₄²⁻.

The Lewis acid preferably comprises organic or inorganic metal compounds in which the cation is selected from the group consisting of scandium, titanium, vanadium, chromium, manganese, iron, cobalt, copper, zinc, boron, aluminum, yttrium, zirconium, niobium, molybdenum, cadmium, rhenium beryllium, gallium, indium, thallium, hafnium, erbium, germanium, tungsten, palladium, thorium and tin. Examples comprise ZnBr₂, ZnI₂, ZnCl₂, ZnSO₄, CuCl₂, CuCl, CU(O₃SCF₃)₂, CoCl₂, CoI₂, FeI₂, FeCl₃, FeCl₂, FeCl₂(THF)₂, TiCl₄(THF)₂, TiCl₄, TiCl₃, CITi(O-i-Propyl)₃, Ti(OMe)₄, Ti(OEt)₄, Ti(O-i-Pr)₄, Ti(O-n-Pr)₄, MnCl₂, ScCl₃, AlCl₃, (C₈H₁₇)AlCl₂, (C₈H₁₇)₂AlCl, (i-C₄H₉)₂AlCl, (C₆H₅)₂AlCl, (C₆H₅)AlCl₂, Al(OMe)3, Al(OEt)₃, Al(O-i-Pr)₃, Al(O-s-Bu)₃, ReCl₅, ZrCl₄, NbCl₅, VCl₃, CrCl₂, MoCl₅, YCl₃, CdCl₂, LaCl₃, Er(O₃SCF₃)₃, Yb(O₂CCF₃)₃, SmCl₃, TaCl₅.

Also useful are organometallic compounds, such as (C₆H₅)₃SnX where X is CF₃SO₃, CH₃C₆H₄SO₃ and RAlCl₂, R₂AlCl, R₃Al, (RO)₃Al, R₃TiCl, (RO)₄Ti, RSnO₃SCF₃, R₃B and B(OR)₃, where R is selected from H, C₁-C₁₂-alkyl, C₆-C₁₈-aryl, C₆-C₁₅-alkylaryl, C₁-C₇-alkyl-substituted aryl free radicals and aryl free radicals substituted with cyano-substituted alkyl groups having 1 to 7 carbon atoms, for example PhAlCl₂, Cu(O₃SCF₃)₃.

The ratio of promoter to catalyst is preferably about 0.1:1 to 50:1 and more preferably about 0.5:1 to 1.2:1.

Suitable alkali metal salts of hydrogen cyanide sources include for example NaCN, KCN and so on.

Suitable solvents are those used above in process stage a).

The proportion of catalyst based on the monofunctionalized dialkylphosphinic acid used is preferably in the range from 0.00001 to 20 mol % and more preferably in the range from 0.00001 to 5 mol %.

The reaction temperature is preferably in the range from 30 to 200° C. and more preferably in the range from 50 to 120° C.

The reaction time is preferably in the range from 0.1 to 20 hours.

Process step c) is preferably carried out at an absolute pressure of 0.1 to 100 bar, more preferably from 0.5 to 10 bar and more particularly from 0.8 to 1.5 bar.

The reaction is preferably carried out under the vapor pressure of the hydrogen cyanide and/or of the solvent.

The reaction is preferably carried out at a hydrogen cyanide partial pressure of 0.01-20 bar and preferably at 0.1-1.5 bar.

The ratio of hydrogen cyanide to dialkylphosphinic acid (VI) is preferably in the range from 10 000:1 to 0.001:1 and more preferably in the range from 30:1 to 0.01:1.

The reaction is preferably carried out in a dialkylphosphinic acid/catalyst molar ratio of 1:1 to 1:0.00000001 and more preferably in a dialkylphosphinic acid/catalyst molar ratio of 1:0.01 to 1:0.000001.

The reaction is preferably carried out in a dialkylphosphinic acid/solvent molar ratio of 1:10 000 to 1:0 and more preferably in a dialkylphosphinic acid/solvent molar ratio of 1:50 to 1:1.

The hydrocyanation of the present invention can be carried out in liquid phase, in the gas phase or else in supercritical phase, in which case the catalyst is used in the case of liquids in homogeneous form or as a suspension, while a fixed bed arrangement is of advantage in the case of gas phase or supercritical operation.

In one embodiment of the present invention, the method of the present invention is carried out continuously.

In a further embodiment of the present invention, the method of the present invention is carried out in liquid phase. Therefore, the pressure in the reactor is preferably adjusted such that the reactants are present in liquid form under the reaction temperature used. It is further preferable to use the hydrogen cyanide in liquid form.

Hydrocyanations can be carried out using one or more reactors which, when two or more reactors are used, are preferably connected in series.

The step d) conversion to the monocarboxy-functionalized dialkylphosphinic acid, salts and esters (III) is achieved by acidic or alkaline hydrolysis in the presence of water of the monofunctionalized dialkylphosphinic acid, salts or esters (VII) using acids or bases in the presence of water by removing the resulting ammonium salt or ammonia.

When a monocarboxy-functionalized dialkylphosphinic acid salt (III) is obtained, it can be reacted with a mineral acid to form the corresponding acid and be esterified with an alcohol M-OH or M′-OH or an alkylene oxide.

When a monocarboxy-functionalized dialkylphosphinic acid ammonium salt (III) is obtained, it can first be reacted with a base to form a monocarboxy-functionalized dialkylphosphinic acid salt which is then reacted with a mineral acid to form the corresponding acid and esterified with an alcohol M-OH or M′-OH or an alkylene oxide.

Suitable mineral acids are for example hydrochloric acid, sulfuric acid, nitric acid or phosphoric acid or mixtures thereof.

Suitable bases are the metals, metal hydrides and metal alkoxides mentioned hereinbelow as catalysts D, for example lithium, lithium hydride, lithium aluminohydride, methyllithium, butyllithium, t-butyllithium, lithium diisopropylamide, sodium, sodium hydride, sodium borohydride, sodium methoxide, sodium ethoxide or sodium butoxide, potassium methoxide, potassium ethoxide or potassium butoxide and also sodium hydroxide, potassium hydroxide, lithium hydroxide and/or barium hydroxide.

The acidic or alkaline hydrolysis may preferably be carried out in the presence of water and an inert solvent. Suitable inert solvents are the solvents mentioned in process step a), preference being given to low molecular weight alcohols having 1 to 6 carbon atoms. The use of saturated aliphatic alcohols is particularly preferred. Examples of suitable alcohols are methanol, ethanol, propanol, i-propanol, butanol, 2-methyl-1-propanol, n-pentanol, 2-pentanol, 3-pentanol, 2-methyl-2-butanol, 3-methyl-2-butanol, 2-methyl-3-butanol, 3-methyl-1-butanol and 2-methyl-1-butanol.

Preferred bases (catalyst D) for carrying out the alkaline hydrolysis are metals, metal hydrides and metal alkoxides such as for example lithium, lithium hydride, lithium aluminohydride, methyllithium, butyllithium, t-butyllithium, lithium diisopropylamide, sodium, sodium hydride, sodium borohydride, sodium methoxide, sodium ethoxide or sodium butoxide, potassium methoxide, potassium ethoxide or potassium butoxide and also sodium hydroxide, potassium hydroxide, lithium hydroxide, barium hydroxide and ammonium hydroxide. Preference is given to using sodium hydroxide, potassium hydroxide and barium hydroxide.

Preferred mineral acids (catalyst D) for carrying out the acidic hydrolysis are for example sulfuric acid, nitric acid, hydrochloric acid, phosphoric acid or mixtures thereof. Preference is given to using sulfuric acid or hydrochloric acid.

The presence of water is essential to carrying out the hydrolysis. The amount of water can range from the stoichiometric requirement as minimum level to an excess.

The hydrolysis is preferably carried out in a phosphorus/water molar ratio of 1:1 to 1:1000 and more preferably in the range from 1:1 to 1:10.

The hydrolysis is preferably carried out in a phosphorus/base or acid molar ratio of 1:1 to 1:300 and more preferably in the range from 1.1 to 1:20.

The amount of alcohol used is generally in the range from 0.5 kg to 1.5 kg per kg of the monofunctionalized dialkylphosphinic acid, salts or esters (VII), preferably in the range from 0.6 kg to 1.0 kg.

The reaction temperature is in the range from 50° C. to 140° C. and preferably in the range from 80° C. to 130° C.

The reaction is preferably carried out at a total pressure in the range from 1 to 100 bar and more preferably at a total pressure in the range from 1 to 10 bar.

The reaction time is in the range from 0.2 to 20 hours and more preferably in the range from 1 to 12 hours.

In one particular embodiment, the monofunctionalized dialkylphosphinic acid, salt or ester (VII) is hydrolyzed with an aqueous barium hydroxide solution to the barium salt of the corresponding monocarboxy-functionalized dialkylphosphinic acid (III) and thereafter reacted with ammonium carbonate or preferably with ammonia followed by carbon dioxide to form the ammonium salt of the monocarboxy-functionalized dialkylphosphinic acid (III) and barium carbonate. The latter can be converted thermally into the free monocarboxy-functionalized dialkylphosphinic acid (III) and ammonia.

The monocarboxy-functionalized dialkylphosphinic acid or salt (III) can thereafter be converted into further metal salts.

The metal compounds which are used in process stage e) preferably comprise compounds of the metals Mg, Ca, Al, Sb, Sn, Ge, Ti, Fe, Zr, Zn, Ce, Bi, Sr, Mn, Li, Na, K, more preferably Mg, Ca, Al, Ti, Zn, Sn, Ce, Fe.

Suitable solvents for process stage e) are those used above in process stage a).

The reaction of process stage e) is preferably carried out in an aqueous medium.

Process stage e) preferably comprises reacting the monocarboxy-functionalized dialkylphosphinic acids, esters and/or alkali metal salts (III) obtained after process stage d) with metal compounds of Mg, Ca, Al, Zn, Ti, Sn, Zr, Ce or Fe to form the monocarboxy-functionalized dialkylphosphinic acid salts (III) of these metals.

The reaction is carried out in a molar ratio of monocarboxy-functionalized dialkylphosphinic acid, ester or salt (III) to metal in the range from 8:1 to 1:3 (for tetravalent metal ions or metals having a stable tetravalent oxidation state), from 6:1 to 1:3 (for trivalent metal ions or metals having a stable trivalent oxidation state), from 4:1 to 1:3 (for divalent metal ions or metals having a stable divalent oxidation state) and from 3:1 to 1:4 (for monovalent metal ions or metals having a stable monovalent oxidation state).

Preferably, monocarboxy-functionalized dialkylphosphinic acid, ester or salt (III) obtained in process stage d) is converted into the corresponding dialkylphosphinic acid and the latter is reacted in process stage e) with metal compounds of Mg, Ca, Al, Zn, Ti, Sn, Zr, Ce or Fe to form the monocarboxy-functionalized dialkylphosphinic acid salts (III) of these metals.

Preferably, monocarboxy-functionalized dialkylphosphinic acid/ester (III) obtained in process stage d) is converted to a dialkylphosphinic acid alkali metal salt and the latter is reacted in process stage e) with metal compounds of Mg, Ca, Al, Zn, Ti, Sn, Zr, Ce or Fe to form the monocarboxy-functionalized dialkylphosphinic acid salts (III) of these metals.

The metal compounds of Mg, Ca, Al, Zn, Ti, Sn, Zr, Ce or Fe for process stage e) preferably comprise metals, metal oxides, hydroxides, oxide hydroxides, borates, carbonates, hydroxocarbonates, hydroxocarbonate hydrates, mixed metal hydroxocarbonates, mixed metal hydroxocarbonate hydrates, phosphates, sulfates, sulfate hydrates, hydroxosulfate hydrates, mixed metal hydroxosulfate hydrates, oxysulfates, acetates, nitrates, fluorides, fluoride hydrates, chlorides, chloride hydrates, oxychlorides, bromides, iodides, iodide hydrates, carboxylic acid derivatives and/or alkoxides.

The metal compounds preferably comprise aluminum chloride, aluminum hydroxide, aluminum nitrate, aluminum sulfate, titanyl sulfate, zinc nitrate, zinc oxide, zinc hydroxide and/or zinc sulfate.

Also suitable are aluminum metal, fluoride, hydroxychloride, bromide, iodide, sulfide, selenide; phosphide, hypophosphite, antimonide, nitride; carbide, hexafluorosilicate; hydride, calcium hydride, borohydride; chlorate; sodium aluminum sulfate, aluminum potassium sulfate, aluminum ammonium sulfate, nitrate, metaphosphate, phosphate, silicate, magnesium silicate, carbonate, hydrotalcite, sodium carbonate, borate, thiocyanate oxide, oxide hydroxide, their corresponding hydrates and/or polyaluminum hydroxy compounds, which preferably have an aluminum content of 9 to 40% by weight.

Also suitable are aluminum salts of mono-, di-, oligo-, polycarboxylic acids such as, for example, aluminum diacetate, acetotartrate, formate, lactate, oxalate, tartrate, oleate, palmitate, stearate, trifluoromethanesulfonate, benzoate, salicylate, 8-oxyquinolate.

Likewise suitable are elemental, metallic zinc and also zinc salts such as for example zinc halides (zinc fluoride, zinc chlorides, zinc bromide, zinc iodide).

Also suitable are zinc borate, carbonate, hydroxide carbonate, silicate, hexafluorosilicate, stannate, hydroxide stannate, magnesium aluminum hydroxide carbonate; nitrate, nitrite, phosphate, pyrophosphate; sulfate, phosphide, selenide, telluride and zinc salts of the oxoacids of the seventh main group (hypohalites, halites, halates, for example zinc iodate, perhalates, for example zinc perchlorate); zinc salts of the pseudohalides (zinc thiocyanate, zinc cyanate, zinc cyanide); zinc oxides, peroxides, hydroxides or mixed zinc oxide hydroxides.

Preference is given to zinc salts of the oxoacids of transition metals (for example zinc chromate(VI) hydroxide, chromite, molybdate, permanganate, molybdate).

Also suitable are zinc salts of mono-, di-, oligo-, polycarboxylic acids, for example zinc formate, acetate, trifluoroacetate, propionate, butyrate, valerate, caprylate, oleate, stearate, oxalate, tartrate, citrate, benzoate, salicylate, lactate, acrylate, maleate, succinate, salts of amino acids (glycine), of acidic hydroxyl functions (zinc phenoxide etc), zinc p-phenolsulfonate, acetylacetonate, stannate, dimethyldithiocarbamate, trifluoromethanesulfonate.

In the case of titanium compounds, metallic titanium is as is titanium(III) and/or (IV) chloride, nitrate, sulfate, formate, acetate, bromide, fluoride, oxychloride, oxysulfate, oxide, n-propoxide, n-butoxide, isopropoxide, ethoxide, 2-ethylhexyl oxide.

Also suitable is metallic tin and also tin salts (tin(II) and/or (IV) chloride); tin oxides and tin alkoxide such as, for example, tin(IV) tert-butoxide.

Cerium(III) fluoride, chloride and nitrate are also suitable.

In the case of zirconium compounds, metallic zirconium is preferred as are zirconium salts such as zirconium chloride, zirconium sulfate, zirconyl acetate, zirconyl chloride. Zirconium oxides and also zirconium (IV) tert-butoxide are also preferred.

The reaction in process stage e) is preferably carried out at a solids content of the monocarboxy-functionalized dialkylphosphinic acid salts in the range from 0.1% to 70% by weight, preferably 5% to 40% by weight.

The reaction in process stage e) is preferably carried out at a temperature of 20 to 250° C., preferably at a temperature of 80 to 120° C.

The reaction in process stage d) is preferably carried out at a pressure between 0.01 and 1000 bar, preferably 0.1 to 100 bar.

The reaction in process stage e) preferably takes place during a reaction time in the range from 1*10⁻⁷ to 1*10² h.

Preferably, the monocarboxy-functionalized dialkylphosphinic acid salt of the metals (III) removed after process stage e) from the reaction mixture by filtration and/or centrifugation is dried.

Preferably, the product mixture obtained after process stage d) is reacted with the metal compounds without further purification.

Preferred solvents are the solvents mentioned in process step a).

The reaction in process stage d) and/or e) is preferably carried out in the solvent system given by stage a), b) and/or c).

The reaction in process stage e) is preferred in a modified given solvent system. Acidic components, solubilizers, foam inhibitors, etc are added for this purpose.

In a further embodiment of the method, the product mixture obtained after process stage a), b), c) and/or d) is worked up.

In a further embodiment of the method, the product mixture obtained after process stage d) is worked up and thereafter the monocarboxy-functionalized dialkylphosphinic acids and/or salts or esters (III) obtained after process stage d) are reacted in process stage e) with the metal compounds.

Preferably, the product mixture after process stage d) is worked up by isolating the monocarboxy-functionalized dialkylphosphinic acids and/or salts or esters (III) by removing the solvent system, for example by evaporation.

Preferably, the monoamino-functionalized dialkylphosphinic acid salt (III) of the metals Mg, Ca, Al, Zn, Ti, Sn, Zr, Ce or Fe selectively has a residual moisture content of 0.01% to 10% by weight, preferably of 0.1% to 1% by weight, an average particle size of 0.1 to 2000 μm, preferably of 10 to 500 μm, a bulk density of 80 to 800 g/l, preferably 200 to 700 g/l, and a Pfrengle flowability of 0.5 to 10, preferably of 1 to 5.

The molded articles, films, threads and fibers more preferably contain from 5% to 30% by weight of the monocarboxy-functionalized dialkylphosphinic acid/ester/salts produced according to one or more of claims 1 to 12, from 5% to 90% by weight of polymer or mixtures thereof, from 5% to 40% by weight of additives and from 5% to 40% by weight of filler, wherein the sum total of the components is always 100% by weight.

The additives preferably comprise antioxidants, antistats, blowing agents, further flame retardants, heat stabilizers, impact modifiers, processing aids, lubricants, light stabilizers, antidripping agents, compatibilizers, reinforcing agents, fillers, nucleus-forming agents, nucleating agents, additives for laser marking, hydrolysis stabilizers, chain extenders, color pigments, softeners, plasticizers and/or plasticizing agents.

Preference is given to a flame retardant containing 0.1 to 90% by weight of the monocarboxy-functionalized dialkylphosphinic acid, ester and salts (III) and 0.1% to 50% by weight of further additives, more preferably diols.

Preferred additives are also aluminum trihydrate, antimony oxide, brominated aromatic or cycloaliphatic hydrocarbons, phenols, ethers, chloroparaffin, hexachlorocyclopentadiene adducts, red phosphorus, melamine derivatives, melamine cyanurates, ammonium polyphosphates and magnesium hydroxide. Preferred additives are also further flame retardants, more particularly salts of dialkylphosphinic acids.

More particularly, the present invention provides for the use of the present invention monocarboxy-functionalized dialkylphosphinic acid, esters and salts (III) as flame retardants or as an intermediate in the manufacture of flame retardants for thermoplastic polymers such as polyesters, polystyrene or polyamide and for thermoset polymers such as unsaturated polyester resins, epoxy resins, polyurethanes or acrylates.

Suitable polyesters are derived from dicarboxylic acids and their esters and diols and/or from hydroxycarboxylic acids or the corresponding lactones.

It is particularly preferable to use terephthalic acid and ethylene glycol, 1,3-propanediol and 1,3-butanediol.

Suitable polyesters include inter alia polyethylene terephthalate, polybutylene terephthalate (Celanex® 2500, Celanex® 2002, from Celanese; Ultradur®, from BASF), poly-1,4-dimethylolcyclohexane terephthalate, polyhydroxybenzoates, and also block polyether esters derived from polyethers having hydroxyl end groups; and also polyesters modified with polycarbonates or MBS.

Synthetic linear polyesters having permanent flame retardancy are composed of dicarboxylic acid components, diol components of the present invention monocarboxy-functionalized dialkylphosphinic acids and ester, or of the monocarboxy-functionalized dialkylphosphinic acids and esters produced by the method of the present invention as phosphorus-containing chain members. The phosphorus-containing chain members account for 2-20% by weight of the dicarboxylic acid component of the polyester. The resulting phosphorus content in the polymer is preferably 0.1-5% by weight, more preferably 0.5-3% by weight.

The following steps can be carried out with or by addition of the compounds produced according to the present invention.

Preferably, the molding material is produced from the free dicarboxylic acid and diols by initially esterifying directly and then polycondensing.

When proceeding from dicarboxylic esters, more particularly dimethyl esters, it is preferable to first transesterify and then to polycondense by using catalysts customary for this purpose.

Polyester production may preferably proceed by adding customary additives (crosslinking agents, matting agents and stabilizing agents, nucleating agents, dyes and fillers, etc) in addition to the customary catalysts.

The esterification and/or transesterification involved in polyester production is preferably carried out at temperatures of 100-300° C., more preferably at 150-250° C.

The polycondensation involved in polyester production preferably takes place at pressures between 0.1 to 1.5 mbar and temperatures of 150-450° C., more preferably at 200-300° C.

The flame-retardant polyester molding materials produced according to the present invention are preferably used in polyester molded articles.

Preferred polyester molded articles are threads, fibers, self-supporting films/sheets and molded articles containing mainly terephthalic acid as dicarboxylic acid component and mainly ethylene glycol as diol component.

The resulting phosphorus content in threads and fibers produced from flame-retardant polyesters is preferably 0.1%-18%, more preferably 0.5%-15% by weight and in the case of self-supporting films/sheets 0.2%-15%, preferably 0.9%-12% by weight.

Suitable polystyrenes are polystyrene, poly(p-methylstyrene) and/or poly(alpha-methylstyrene).

Suitable polystyrenes preferably comprise copolymers of styrene or alpha-methylstyrene with dienes or acrylic derivatives, for example styrene-butadiene, styrene-acrylonitrile, styrene-alkyl methacrylate, styrene-butadiene-alkyl acrylate and styrene-butadiene-alkyl methacrylate, styrene-maleic anhydride, styreneacrylonitrile-methyl acrylate; mixtures of high impact strength from styrene copolymers and another polymer, for example a polyacrylate, a diene polymer or an ethylene-propylene-diene terpolymer; also block copolymers of styrene, for example styrene-butadiene-styrene, styrene-isoprene-styrene, styreneethylene/butylene-styrene or styrene-ethylene/propylene-styrene.

Suitable polystyrenes preferably also comprise graft copolymers of styrene or alpha-methylstyrene, for example styrene on polybutadiene, styrene on polybutadiene-styrene or polybutadiene-acrylonitrile copolymers, styrene and acrylonitrile (or methacrylonitrile) on polybutadiene; styrene, acrylonitrile and methyl methacrylate on, polybutadiene; styrene and maleic anhydride on polybutadiene; styrene, acrylonitrile and maleic anhydride or maleimide on polybutadiene; styrene and maleimide on polybutadiene, styrene and alkyl acrylates or alkyl methacrylates on polybutadiene, styrene and acrylonitrile on ethylene-propylene-diene terpolymers, styrene and acrylonitrile on poly(alkyl acrylate)s or poly(alkyl methacrylate)s, styrene and acrylonitrile on acrylatebutadiene copolymers, and also their mixtures, as are also known for example as ABS, MBS, ASA or AES polymers.

The polymers preferably comprise polyamides and copolyamides derived from diamines and dicarboxylic acids and/or from aminocarboxylic acids or the corresponding lactams, such as nylon-2,12, nylon-4, nylon-4,6, nylon-6, nylon-6,6, nylon-6,9, nylon-6,10, nylon-6,12, nylon-6,66, nylon-7,7, nylon-8,8, nylon-9,9, nylon-10,9, nylon-10,10, nylon-11, nylon-12, and so on. Such polyamides are known for example under the trade names Nylon®, from DuPont, Ultramid®, from BASF, Akulon® K122, from DSM, Zytel® 7301, from DuPont; Durethan® B 29, from Bayer and Grillamid®, from Ems Chemie.

Also suitable are aromatic polyamides proceeding from m-xylene, diamine and adipic acid; polyamides produced from hexamethylenediamine and iso- and/or terephthalic acid and optionally an elastomer as modifier, for example poly-2,4,4-trimethylhexamethyleneterephthalamide or poly-m-phenyleneisophthalamide, block copolymers of the aforementioned polyamides with polyolefins, olefin copolymers, ionomers or chemically bonded or grafted elastomers or with polyethers, for example with polyethylene glycol, polypropylene glycol or polytetramethylene glycol. Also EPDM- or ABS-modified polyamides or copolyamides; and also polyamides condensed during processing (“RIM polyamide systems”).

The monocarboxy-functionalized dialkylphosphinic acid/ester/salts produced according to one or more of claims 1 to 12 are preferably used in molding materials further used for producing polymeric molded articles.

It is particularly preferable for the flame-retardant molding material to contain from 5% to 30% by weight of monocarboxy-functionalized dialkylphosphinic acids, salts or esters produced according to one or more of claims 1 to 12, from 5% to 90% by weight of polymer or mixtures thereof, from 5% to 40% by weight of additives and 5% to 40% by weight of filler, wherein the sum total of the components is always 100% by weight.

The present invention also provides flame retardants containing monocarboxyfunctionalized dialkylphosphinic acids, salts or esters produced according to one or more of claims 1 to 12.

The present invention also provides polymeric molding materials and also polymeric molded articles, films, threads and fibers containing the monocarboxyfunctionalized dialkylphosphinic acid salts (III) of the metals Mg, Ca, Al, Zn, Ti, Sn, Zr, Ce or Fe produced according to the present invention.

The examples which follow illustrate the invention.

Production, processing and testing of flame-retardant polymeric molding materials and flame-retardant polymeric molded articles.

The flame-retardant components are mixed with the polymeric pellets and any additives and incorporated on a twin-screw extruder (Leistritz LSM® 30/34) at temperatures of 230 to 260° C. (glassfiber-reinforced PBT) or of 260 to 280° C. (glassfiber-reinforced PA 66). The homogenized polymeric strand was hauled off, water bath cooled and then pelletized.

After sufficient drying, the molding materials were processed on an injection molding machine (Aarburg Allrounder) at melt temperatures of 240 to 270° C. (glassfiber-reinforced PBT) or of 260 to 290° C. (glassfiber-reinforced PA 66) to give test specimens. The test specimens are subsequently flammability tested and classified using the UL 94 (Underwriter Laboratories) test.

UL 94 (Underwriter Laboratories) fire classification was determined on test specimens from each mixture, using test specimens 1.5 mm in thickness.

The UL 94 fire classifications are as follows:

V-0: Afterflame time never longer than 10 sec, total of afterflame times for 10 flame applications not more than 50 sec, no flaming drops, no complete consumption of the specimen, afterglow time for specimens never longer than 30 sec after end of flame application.
V-1: Afterflame time never longer than 30 sec after end of flame application, total of afterflame time for 10 flame applications not more than 250 sec, afterglow time for specimens never longer than 60 sec after end of flame application, other criteria as for V-0
V-2: Cotton indicator ignited by flaming drops, other criteria as for V-1

Not classifiable (ncl): does not comply with fire classification V-2.

Some investigated specimens were also tested for their LOI value. The LOI (Limiting Oxygen Index) value is determined according to ISO 4589. According to ISO 4589, the LOI is the lowest oxygen concentration in volume percent which in a mixture of oxygen and nitrogen will support combustion of the plastic. The higher the LOI value, the greater the flammability resistance of the material tested.

| | | |
|---|---|---|
| LOI | 23 | flammable |
| LOI | 24-28 | potentially flammable |
| LOI | 29-35 | flame resistant |
| LOI | >36 | particularly flame-resistant |

### Chemicals and Abbreviations Used

VE water completely ion-free water
AIBN azobis(isobutyronitrile), (from WAKO Chemicals GmbH)
THF tetrahydrofuran
WakoV65 2,2′-azobis(2,4-dimethylvaleronitrile), (from WAKO Chemicals GmbH)
Deloxan® THP II metal scavenger (from Evonik Industries AG)

### EXAMPLE 1

At room temperature, a three-neck flask equipped with stirrer and high-performance condenser is initially charged with 188 g of water and this initial charge is devolatilized by stirring and passing nitrogen through it. Then, under nitrogen, 0.2 mg of palladium(II) sulfate and 2.3 mg of tris(3-sulfophenyl)phosphine trisodium salt are added, the mixture is stirred, and then 66 g of phosphinic acid in 66 g of water are added. The reaction solution is transferred to a 2 l Büchi reactor and charged with ethylene under superatmospheric pressure while stirring and the reaction mixture is heated to 80° C. After 28 g of ethylene has been taken up, the system is cooled down and free ethylene is discharged. The reaction mixture is freed of solvent on a rotary evaporator. The residue is admixed with 100 g of VE water and at room temperature stirred under nitrogen, then filtered and the filtrate is extracted with toluene, thereafter freed of solvent on a rotary evaporator and 92 g (98% of theory) of ethylphosphonous acid are collected.

### EXAMPLE 2

Example 1 is repeated with 99 g of phosphinic acid, 396 g of butanol, 42 g of ethylene, 6.9 mg of tris(dibenzylideneacetone)dipalladium, 9.5 mg of 4,5-bis(diphenylphosphino)-9,9-dimethylxanthene, followed by purification over a column charged with Deloxan® THP II and the further addition of n-butanol. At a reaction temperature of 80-110° C., the water formed is removed by azeotropic distillation. The product is purified by distillation at reduced pressure. Yield: 189 g (84% of theory) of butyl ethylphosphonite.

### EXAMPLE 3

Example 1 is repeated with 198 g of phosphinic acid, 198 g of water, 84 g of ethylene, 6.1 mg of palladium(II) sulfate, 25.8 mg of 9,9-dimethyl-4,5-bis(diphenylphosphino)-2,7-sulfonatoxanthene disodium salt, followed by purification over a column charged with Deloxan® THP II and the further addition of n-butanol. At a reaction temperature of 80-110° C., the water formed is removed by azeotropic distillation. The product is purified by distillation at reduced pressure.

Yield: 374 g (83% of theory) of butyl ethylphosphonite.

### EXAMPLE 4

A 500 ml five-neck flask equipped with gas inlet tube, thermometer, high-performance stirrer and reflux condenser with gas incineration is charged with 94 g (1 mol) of ethylphosphonous acid (produced as in Example 1). Ethylene oxide is introduced at room temperature. A reaction temperature of 70° C. is set with cooling, followed by further reaction at 80° C. for one hour. The ethylene oxide takeup is 65.7 g. The acid number of the product is less than 1 mg KOH/g. Yield: 129 g (94% of theory) of 2-hydroxyethyl ethylphosphonite as colorless, water-clear product.

### EXAMPLE 5

At room temperature, a three-neck flask equipped with stirrer and high-performance condenser is initially charged with 400 g of THF and this initial charge is devolatilized by stirring and passing nitrogen through it. Then, under nitrogen, 1.35 g (6 mmol) of palladium acetate and 4.72 g (18 mmol) of triphenylphosphine are added and stirred in, then 30 g (0.2 mol) of butyl ethylphosphonite (produced as in Example 2) and 1.96 g (9 mmol) of diphenylphosphinic acid are added and the reaction mixture is heated to 80° C. and acetylene is passed through the reaction solution at a rate of 5 l/h. After a reaction time of 5 hours, the acetylene is expelled from the apparatus using nitrogen. For purification, the reaction solution is passed through a column charged with Deloxan® THP II and the THF is removed in vacuo. The product is purified by distillation at reduced pressure. This gives 32.7 g (93% of theory) of butyl ethylvinylphosphinate as colorless oil.

### EXAMPLE 6

At room temperature, a three-neck flask equipped with stirrer and high-performance condenser is initially charged with 400 g of acetic acid and this initial charge is devolatilized by stirring and passing nitrogen through it. Then, under nitrogen, 1.35 g (6 mmol) of palladium acetate and 3.47 g (6 mmol) of xantphos are added and stirred in, then 19 g (0.2 mol) of ethylphosphonous acid (produced as in Example 1) are added and the reaction mixture is heated to 80° C. and acetylene is passed through the reaction solution at a rate of 5 l/h. After a reaction time of 5 hours, the acetylene is expelled from the apparatus using nitrogen. For purification, the reaction solution is passed through a column charged with Deloxan® THP II and the acetic acid is removed in vacuo. The product (ethylvinylphosphinic acid) is purified by chromatography. This gives 20.9 g (87% of theory) of ethylvinylphosphinic acid as colorless oil.

### EXAMPLE 7

At room temperature, a three-neck flask equipped with stirrer and high-performance condenser is initially charged with 400 g of toluene and this initial charge is devolatilized by stirring and passing nitrogen through it. Under nitrogen, 5.55 g (6 mmol) of RhCl(PPh₃)₃ are added and stirred in, followed by 30 g (0.2 mol) of butyl ethylphosphonite (produced as in Example 3) and 20.4 g (0.2 mol) of phenylacetylene, and the reaction mixture is heated to 80° C. Following a reaction time of 5 hours, the reaction solution is passed through a column charged with Deloxan® THP II and the toluene is removed in vacuo to give 37.6 g (96% of theory) of butyl ethyl(1-phenylvinyl)phosphinate as colorless oil.

### EXAMPLE 8

At room temperature, a three-neck flask equipped with stirrer and high-performance condenser is initially charged with 400 g of THF and this initial charge is devolatilized by stirring and passing nitrogen through it. Then, under nitrogen, 2.75 g (10 mmol) of bis(cyclooctadiene)nickel(0) and 8 g (40 mmol) of methyldiphenylphosphine are added and stirred in, followed by 30 g (0.2 mol) of butyl ethylphosphonite (produced as in Example 2) and acetylene is passed through the reaction solution at a rate of 5 l/h at room temperature. Following a reaction time of 5 hours, the acetylene is expelled from the apparatus using nitrogen. For purification, the reaction solution is passed through a column charged with Deloxan® THP II and the butanol is removed in vacuo to leave 33.4 g (95% of theory) of butyl ethylvinylphosphinate as colorless oil.

### EXAMPLE 9

360 g (3 mol) of the resulting ethylvinylphosphinic acid (produced as in Example 6) are at 85° C. dissolved in 400 ml of toluene and admixed with 888 g (12 mol) of butanol. At a reaction temperature of about 100° C., the water formed is removed by azeotropic distillation. The butyl ethylvinylphosphinate product is purified by distillation at reduced pressure.

### EXAMPLE 10

360 g (3.0 mol) of ethylvinylphosphinic acid (produced as in Example 6) are at 80° C. dissolved in 400 ml of toluene and admixed with 315 g (3.5 mol) of 1,4-butanediol and esterified at about 100° C. in a distillation apparatus equipped with water trap during 4 h. On completion of the esterification the toluene is removed in vacuo to leave 518 g (90% of theory) of 4-hydroxybutyl ethylvinylphosphinate as colorless oil.

### EXAMPLE 11

360 g (3.0 mol) of ethylvinylphosphinic acid (produced as in Example 6) are at 85° C. dissolved in 400 ml of toluene and admixed with 248 g (4 mol) of ethylene glycol and esterified at about 100° C. in a distillation apparatus equipped with water trap during 4 h. On completion of the esterification the toluene and excess ethyl glycol is removed in vacuo to leave 462 g (94% of theory) of 2-hydroxyethyl ethylvinylphosphinate as colorless oil.

### EXAMPLE 12

At room temperature, a three-neck flask equipped with stirrer and high-performance condenser is initially charged with 400 g of acetonitrile and this initial charge is devolatilized by stirring and passing argon through it. Then, under argon, 0.275 g (1 mmol) of bis(cyclooctadiene)nickel(0) and 0.931 g (3 mmol) of triphenyl phosphite are added and stirred in, followed by 120 g (1.0 mol) of ethylvinylphosphinic acid (produced as in Example 6) and 0.136 g (1 mmol) of zinc dichloride, the reaction mixture is heated to 80° C. and hydrogen cyanide is passed through the reaction solution at a rate of 10 l/h in an argon carrier stream. Following a reaction time of 3 hours, the hydrogen cyanide is expelled from the apparatus using argon. For purification, the reaction solution is passed through a column charged with Deloxan® THP II and the acetonitrile is removed in vacuo to leave 144 g (98% of theory) of ethyl(2-cyanoethyl)phosphinic acid as colorless oil.

### EXAMPLE 13

At room temperature, a three-neck flask equipped with stirrer and high-performance condenser is initially charged with 196 g (1.0 mol) of butyl ethyl(1-phenylvinyl)phosphinate (produced as in Example 7) and this initial charge is devolatilized by stirring and passing argon through it. Then, under argon, 0.275 g (1 mmol) of bis(cyclooctadiene)nickel(0) and 0.931 g (3 mmol) of triphenyl phosphite and 0.242 g (1 mmol) of triphenylborane are added and stirred in, the reaction mixture is heated to 80° C. and hydrogen cyanide is passed through the reaction solution at a rate of 10 l/h in an argon carrier stream. Following a reaction time of 3 hours, the hydrogen cyanide is expelled from the apparatus using argon to leave 248 g (89% of theory) of butyl ethyl(2-cyano-1-phenyl)phosphinate as colorless oil.

### EXAMPLE 14

441 g (3 mol) of ethyl(2-cyanoethyl)phosphinic acid (produced as in Example 12) are at 85° C. dissolved in 400 ml of toluene and admixed with 888 g (12 mol) of butanol. At a reaction temperature of about 100° C., the water formed is removed by azeotropic distillation. The butyl ethyl(2-cyanoethyl)phosphinate product is purified by distillation at reduced pressure to leave 585 g (96% of theory) of butyl ethyl(2-cyanoethyl)phosphinate as colorless oil.

### EXAMPLE 15

441 g (3.0 mol) of ethyl-2-cyanoethylphosphinic acid (produced as in Example 12) are at 80° C. dissolved in 400 ml of toluene and admixed with 315 g (3.5 mol) of 1,4-butanediol and esterified at about 100° C. in a distillation apparatus equipped with water trap during 4 h. On completion of the esterification the toluene and excess ethyl glycol is removed in vacuo to leave 604 g (92% of theory) of 4-hydroxybutyl ethyl(2-cyanoethyl)phosphinate as colorless oil.

### EXAMPLE 16

441 g (3.0 mol) of ethyl(2-cyanoethyl)phosphinic acid (produced as in Example 12) are at 85° C. dissolved in 400 ml of toluene and admixed with 248 g (4 mol) of ethylene glycol and esterified at about 100° C. in a distillation apparatus equipped with water trap during 4 h. On completion of the esterification the toluene and excess ethyl glycol is removed in vacuo to leave 510 g (89% of theory) of 2-hydroxyethyl ethyl-2-cyanoethylphosphinate as colorless oil.

### EXAMPLE 17

In a stirred apparatus, 147 g (1 mol) of ethyl(2-cyanoethyl)phosphinic acid (produced as in Example 12) are dissolved in 200 ml (2 mol) of concentrated hydrochloric acid. The efficiently stirred mixture was heated to about 90° C. and reacted at that temperature for about 6 hours. The reaction solution is cooled down, and ammonium hydrochloride formed is filtered off. Concentrating the reaction solution results in further precipitation of ammonium hydrochloride, which is removed by filtering the hot reaction solution. The water is then completely distilled off in vacuo. The residue is taken up in acetic acid and extracted. The insoluble salts are filtered off. The solvent of the filtrate is removed in vacuo and the residue is recrystallized from acetone to obtain 161 g (97% of theory) of 3-(ethylhydroxyphosphinyl)propionic acid as a solid material.

### EXAMPLE 18

In a stirred apparatus, 203 g (1 mol) of butyl ethyl(2-cyanoethyl)phosphinate (produced as in Example 14) are dissolved in 200 ml (2 mol) of concentrated hydrochloric acid. The efficiently stirred mixture was heated to about 90° C. and reacted at that temperature for about 8 hours. The reaction solution is cooled down, and ammonium hydrochloride formed is filtered off. Concentrating the reaction solution results in further precipitation of ammonium hydrochloride, which is removed by filtering the hot reaction solution. The water is then completely distilled off in vacuo. The residue is taken up in acetic acid and extracted. The insoluble salts are filtered off. The solvent of the filtrate is removed in vacuo and the residue is recrystallized from acetone to obtain 156 g (94% of theory) of 3-(ethylhydroxyphosphinyl)propionic acid as a solid material.

### EXAMPLE 19

A stirred apparatus is initially charged with 150 g of butanol, 65 g of water, 150 g (3.75 mol) of sodium hydroxide and 183 g (1.25 mol) of ethyl(2-cyanoethyl)phosphinic acid (produced as in Example 12). The efficiently stirred mixture was heated to about 120° C. and reacted at that temperature for about 6 hours. Then, 250 ml of water were added and the butanol was removed from the reaction mixture by distillation. Following the addition of a further 500 ml of water, the mixture is neutralized by addition of about 184 g (1.88 mol) of concentrated sulfuric acid. The water is then distilled off in vacuo. The residue is taken up in tetrahydrofuran and extracted. The insoluble salts are filtered off. The solvent of the filtrate is removed in vacuo and the residue is recrystallized from acetone to obtain 203 g (98% of theory) of 3-(ethylhydroxyphosphinyl)propionic acid as a solid material.

### EXAMPLE 20

A stirred apparatus is initially charged with 150 g of ethanol, 65 g of water, 150 g (3.75 mol) of sodium hydroxide and 183 g (1.25 mol) of ethyl(2-cyanoethyl)phosphinic acid (produced as in Example 12). The mixture was heated under reflux and reacted at that temperature for about 10 hours. Then water and the butanol were removed from the reaction mixture by distillation. Following the addition of a further 500 ml of water, the mixture was neutralized by addition of about 61 g (0.63 mol) of concentrated sulfuric acid. The water is then distilled off in vacuo. The residue is taken up in ethanol and the insoluble salts are filtered off. The solvent of the filtrate is removed in vacuo to obtain 234 g (89% of theory) of 3-(ethylhydroxyphosphinyl)propionic acid sodium salt as a solid material.

### EXAMPLE 21

A stirred apparatus is initially charged with 150 g of butanol, 65 g of water, 150 g (3.75 mol) of sodium hydroxide and 349 g (1.25 mol) of butyl ethyl(2-cyano-1-phenyl)phosphinate (produced as in Example 13). The efficiently stirred mixture was heated to about 120° C. and reacted at that temperature for about 8 hours. Then, 250 ml of water were added and the butanol was removed from the reaction mixture by distillation. Following the addition of a further 500 ml of water, the mixture was neutralized by addition of about 184 g (1.88 mol) of concentrated sulfuric acid. The water is then distilled off in vacuo. The residue is taken up in tetrahydrofuran and extracted. The insoluble salts are filtered off. The solvent of the filtrate is removed in vacuo and the residue is recrystallized from acetone to obtain 290 g (96% of theory) of 3-(ethylhydroxyphosphinyl)-3-phenylpropionic acid as a solid material.

### EXAMPLE 22

498 g (3 mol) of 3-(ethylhydroxyphosphinyl)propionic acid (produced as in Example 17) are dissolved in 860 g of water and initially charged into a 5 l five-neck flask equipped with thermometer, reflux condenser, hight-performance stirrer and dropping funnel and neutralized with about 480 g (6 mol) of 50% sodium hydroxide solution. The water is subsequently distilled off in vacuo to leave 624 g (99% of theory) of 3-(ethylhydroxyphosphinyl)propionic acid sodium salt as a solid material.

### EXAMPLE 23

630 g (3 mol) of 3-(ethylhydroxyphosphinyl)propionic acid sodium salt (produced as in Example 20) are dissolved in 860 g of water and initially charged into a 5 l five-neck flask equipped with thermometer, reflux condenser, high-performance stirrer and dropping funnel and neutralized by addition of about 147 g (1.5 mol) of concentrated sulfuric acid. The water is subsequently distilled off in vacuo. The residue is taken up in ethanol and the insoluble salts are filtered off. The solvent of the filtrate is removed in vacuo to leave 488 g (98% of theory) of 3-(ethylhydroxyphosphinyl)propionic acid as a solid material.

### EXAMPLE 24

996 g (6 mol) of 3-(ethylhydroxyphosphinyl)propionic acid (produced as in Example 18) are dissolved in 860 g of water and initially charged into a 5 l five-neck flask equipped with thermometer, reflux condenser, high-performance stirrer and dropping funnel and neutralized with about 960 g (12 mol) of 50% sodium hydroxide solution. A mixture of 2583 g of a 46% aqueous solution of Al₂(SO₄)₃.14 H₂O is added at 85° C. The solid material obtained is subsequently filtered off, washed with hot water and dried at 130° C. in vacuo. Yield: 1026 g (94% of theory) of 3-(ethylhydroxyphosphinyl)propionic acid aluminum(III) salt as colorless salt.

### EXAMPLE 25

166 g (1 mol) of 3-(ethylhydroxyphosphinyl)propionic acid (produced as in Example 17) and 170 g of titanium tetrabutoxide are refluxed in 500 ml of toluene for 40 hours. The resulting butanol is distilled off from time to time with proportions of toluene. The solution formed is subsequently freed of solvent to leave 171 g (91% of theory) of 3-(ethylhydroxyphosphinyl)propionic acid titanium salt.

### EXAMPLE 26

498 g (3 mol) of the 3-(ethylhydroxyphosphinyl)propionic acid obtained (produced as in Example 19) are at 85° C. dissolved in 400 ml of toluene and admixed with 888 g (12 mol) of butanol. At a reaction temperature of about 100° C., the water formed is removed by azeotropic distillation. The butyl 3-(ethylbutoxyphosphinyl)propionate product is purified by distillation at reduced pressure.

### EXAMPLE 27

726 g (3.0 mol) of 3-(ethylhydroxyphosphinyl)-3-phenylpropionic acid (produced as in Example 21) are at 80° C. dissolved in 400 ml of toluene and admixed with 594 g (6.6 mol) of 1,4-butanediol and esterified at about 100° C. in a distillation apparatus equipped with water trap during 4 h. On completion of the esterification the toluene is removed in vacuo to leave 1065 g (92% of theory) of 4-hydroxybutyl 3-(ethyl-4-hydroxybutylphosphinyl)-3-phenylpropionate as colorless oil.

### EXAMPLE 28

To 276 g (2 mol) of butyl 3-(ethylbutoxyphosphinyl)propionate (produced as in Example 26) are added 155 g (2.5 mol) of ethylene glycol and 0.4 g of potassium titanyloxalate, followed by stirring at 200° C. for 2 h. Volatiles are distilled off by gradual evacuation to leave 244 g (98% of theory) of 2-hydroxyethyl 3-(ethyl-2-hydroxyethoxyphosphinyl)propionate.

### EXAMPLE 29

Terephthalic acid, ethylene glycol and 2-hydroxyethyl 3-(ethyl-2-hydroxyethylphosphinyl)propionate (produced as in Example 28) are polymerized in a weight ratio of 1000:650:90 in the presence of zinc acetate and antimony(III) oxide under the usual conditions. To 25.4 g of 2-hydroxyethyl 3-(ethyl-2-hydroxyethylphosphinyl)propionate are added 290 g of terephthalic acid, 188 g of ethylene glycol and 0.34 g of zinc acetate, and the mixture is heated to 200° C. for 2 h. Then, 0.29 g of trisodium phosphate anhydrate and 0.14 g of antimony(III) oxide are added, followed by heating to 280° C. and subsequent evacuation. The melt obtained (357 g, phosphorus content 0.9%) is used to injection mold test specimens 1.6 mm in thickness for measurement of the limiting oxygen index (LOI) to ISO 4589-2 and also for the UL 94 (Underwriter Laboratories) flammability test. The test specimens thus produced gave an LOI of 42% O₂ and were UL 94 classified as flammability class V-0. Corresponding test specimens without 2-hydroxyethyl 3-(ethyl-2-hydroxyethylphosphinyl)propionate gave an LOI of just 31% O₂ and were UL 94 classified as flammability class V-2 only. The polyester molded article containing 2-hydroxyethyl 3-(ethyl-2-hydroxyethylphosphinyl)propionate hence clearly has flame-retardant properties.

### EXAMPLE 30

To 14.0 g of 3-(ethylhydroxyphosphinyl)propionic acid (produced according to Example 17) are added to 12.9 g of 1,3-propylene glycol and at 160° C. the water formed by esterification is stripped off. Then, 378 g of dimethyl terephthalate, 152 g of 1,3-propanediol, 0.22 g of tetrabutyl titanate and 0.05 g of lithium acetate are added and the mixture is heated at 130 to 180° C. for 2 h with stirring and thereafter at 270° C. at underpressure. The polymer (438 g) contains 0.6% of phosphorus, the LOI is 34.

### EXAMPLE 31

To 14.0 g of 3-(ethylhydroxyphosphinyl)propionic acid (produced according to Example 18) are added 367 g of dimethyl terephthalate, 170 g of 1,4-butanediol, 0.22 g of tetrabutyl titanate and 0.05 g of lithium acetate and the mixture is initially heated at 130 to 180° C. for 2 h with stirring and thereafter at 270° C. at underpressure. The polymer (427 g) contains 0.6% of phosphorus, the LOI is 34, the LOI of untreated polybutylene terephthalate is 23.

### EXAMPLE 32

In a 250 ml five-neck flask equipped with reflux condenser, stirrer, thermometer and nitrogen inlet, 100 g of a bisphenol A bisglycidyl ether having an epoxy value of 0.55 mol/100 g (Beckopox EP 140, from Solutia) and 21.6 g (0.13 mol) of 3-(ethylhydroxyphosphinyl)propionic acid (produced as in Example 19) are heated to not more than 150° C. with stirring. A clear melt forms after 30 min. After a further hour of stirring at 150° C., the melt is cooled down and triturated to obtain 118.5 g of a white powder having a phosphorus content of 3.3% by weight.

### EXAMPLE 33

In a 2 L flask equipped with stirrer, water trap, thermometer, reflux condenser and nitrogen inlet, 29.4 g of phthalic anhydride, 19.6 g of maleic anhydride, 24.8 g of propylene glycol, 18.7 g of 2-hydroxyethyl 3-(ethyl-2-hydroxyethylphosphinyl)propionate (produced according to Example 28), 20 g of xylene and 50 mg of hydroquinone are heated to 100° C. while stirring and with nitrogen being passed through. After the reaction has died down, stirring is continued at about 190° C. After 14 g of water have been separated off, the xylene is distilled off and the polymer melt is cooled down. This gives 91.5 g of a white powder having a phosphorus content of 2.3% by weight.

### EXAMPLE 34

A mixture of 50% by weight of polybutylene terephthalate, 20% by weight of 3-(ethylhydroxyphosphinyl)propionic acid aluminium(III) salt (produced as in Example 24) and 30% by weight of glass fibers are compounded on a twin-screw extruder (Leistritz LSM 30/34) at temperatures of 230 to 260° C. to form a polymeric molding material. The homogenized polymeric strand was hauled off, water bath cooled and then pelletized. After drying, the molding materials are processed on an injection molding machine (Aarburg Allrounder) at 240 to 270° C. to form polymeric molded articles which achieved a UL-94 classification of V-0.

### EXAMPLE 35

A mixture of 53% by weight of nylon-6,6, 30% by weight of glass fibers, 17% by weight of 3-(ethylhydroxyphosphinyl)propionic acid titanium salt (produced as in Example 25) are compounded on a twin-screw extruder (Leistritz LSM 30/34) to form polymeric molding materials. The homogenized polymeric strand was hauled off, water bath cooled and then pelletized. After drying, the molding materials are processed on an injection molding machine (Aarburg Allrounder) at 260 to 290° C. to form polymeric molded articles which achieved a UL-94 classification of V-0.

1. A method for producing monocarboxy-functionalized dialkylphosphinic acids, esters or salts, comprising the steps of
a) reacting a phosphinic acid source (I) 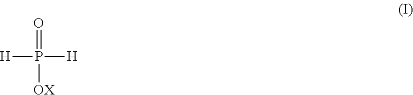
with one or more olefins (IV) 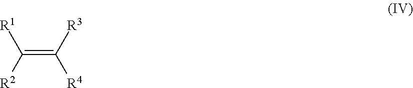
in the presence of a catalyst A to form an alkylphosphonous acid, salt or ester (II) 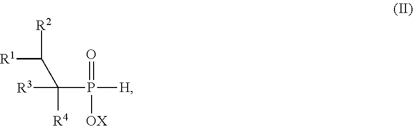
b) reacting the alkyllphosphonous acid, salt or ester (II) with one or more acetylenic compounds of the formula (V) in the presence of a catalyst B 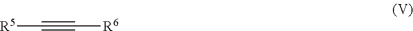
to form a monofunctionalized dialkylphosphinic acid derivative (VI) 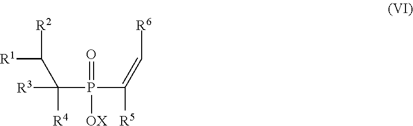
c) reacting the monofunctionalized dialkylphosphinic acid derivative (VI) with a hydrogen cyanide source in the presence of a catalyst C to form the monofunctionalized dialkylphosphinic acid derivative (VII) 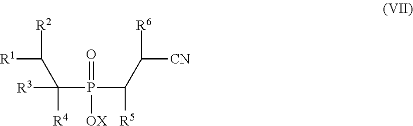
and
d) reacting the monofunctionalized dialkylphosphinic acid derivative (VII) in the presence of a catalyst D to form the monocarboxy-functionalized dialkylphosphinic acid derivative (III) 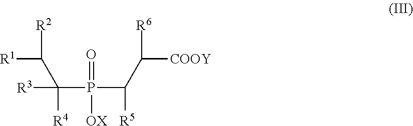
where R¹, R², R³, R⁴, R⁵, R⁶ are identical or different and are each independently H, C₁-C₁₈-alkyl, C₆-C₁₈-aryl, C₆-C₁₈-aralkyl, C₆-C₁₈-alkylaryl, CN, CHO, OC(O)CH₂CN, CH(OH)C₂H₅, CH₂CH(OH)CH₃, 9-anthracene, 2-pyrrolidone, (CH₂)ₘOH, (CH₂)ₘNH₂, (CH₂)ₘNCS, (CH₂)ₘNC(S)NH₂, (CH₂)ₘSH, (CH₂)ₘS-2-thiazoline, (CH₂)ₘSiMe₃, C(O)R⁷, (CH₂)ₘC(O)R⁷, CH═CHR⁷ or CH═CH—C(O)R⁷ and where R⁷ is C₁-C₈-alkyl or C₆-C₁₃-aryl and m is an integer from 0 to 100 and X and Y are identical or different and are each independently H, C₁-C₁₈-alkyl, C₆-C₁₈-aryl, C₆-C₁₈-aralkyl, C₆-C₁₈alkylaryl, (CH₂)ₖOH, CH₂—CHOH—CH₂OH, (CH₂)ₖ—O—(CH₂)ₖH, (CH₂)ₖ—CH(OH)—(CH₂)ₖH, (CH₂—CH₂O)ₖH, (CH₂—C[CH₃]HO)ₖH, (CH₂—C[CH₃]HO)ₖ(CH₂—CH₂O)ₖH, (CH₂—CH₂O)ₖ(CH₂—C[CH₃]HO)H, (CH₂—CH₂O)ₖ-alkyl, (CH₂—C[CH₃]HO)ₖ-alkyl, (CH₂—C[CH₃]HO)ₖ(CH₂—CH₂O)ₖ-alkyl, (CH₂—CH₂O)ₖ(CH₂—C[CH₃]HO)O-alkyl, (CH₂)ₖ—CH═CH(CH₂)ₖH, (CH₂)ₖNH₂, or (CH₂)ₖN[(CH₂)ₖH]₂, where k is an integer from 0 to 10, Mg, Ca, Al, Sb, Sn, Ge, Ti, Fe, Zr, Zn, Ce, Bi, Sr, Mn, Cu, Ni, Li, Na, K, H, a protonated nitrogen base or a combination thereof and the catalysts A, B and C are transition metals, transition metal compounds, catalyst systems composed of a transition metal or a transition metal compound and at least one ligand or a combination thereof, and the catalyst D base.

2. The method according to claim 1 wherein the monocarboxy-functionalized dialkylphosphinic acid, its salt or ester (III) obtained after step d) is reacted in a step e) with metal compounds of Mg, Ca, Al, Sb, Sn, Ge, Ti, Fe, Zr, Zn, Ce, Bi, Sr, Mn, Li, Na, K, a protonated nitrogen base or a combination thereof to form the monocarboxyfunctionalized dialkylphosphinic acid salts (III) of these metals, of a nitrogen compound or a combination thereof.

3. The method according to claim 1 wherein the alkylphosphonous acid, salt or ester (II) obtained after step a), the monofunctionalized dialkylphosphinic acid, salt or ester (VI) obtained after step b), the monofunctionalized dialkylphosphinic acid, salt or ester (VII) obtained after step c), the monocarboxy-functionalized dialkylphosphinic acid, salt or ester (III) obtained after step d), the resulting reaction solution thereof or a combination thereof are esterified with an alkylene oxide or an alcohol M-OH M′-OH or a combination thereof, and the alkylphosphonous ester (II), monofunctionalized dialkylphosphinic ester (VI), monofunctionalized dialkylphosphinic ester (VII), monocarboxy-functionalized dialkylphosphinic ester (III) or a combination thereof are subjected to the reaction steps b), c), d) or e).

4. The method according to claim 1, wherein the groups C₆-C₁₈-aryl, C₆-C₁₈-aralkyl and C₆-C₁₈-alkylaryl are substituted with SO₃X₂, —C(O)CH₃, OH, CH₂OH, CH₃SO₃X₂, PO₃X₂, NH₂, NO₂, OCH₃, SH, OC(O)CH₃ or a combination thereof.

5. The method according to claim 1, wherein R¹, R², R³, R⁴, R⁵, R⁶ are identical or different and are each independently H, methyl, ethyl, n-propyl, isopropyl, n-butyl, isobutyl, tert-butyl or phenyl.

6. The method according to claim 1, wherein X and Y are identical or different and are each H, Ca, Mg, Al, Zn, Ti, Mg, Ce, Fe, methyl, ethyl, n-propyl, isopropyl, n-butyl, isobutyl, tert-butyl, phenyl, ethylene glycol, propyl glycol, butyl glycol, pentyl glycol, hexyl glycol, allyl glycerol or a combination thereof.

7. The method according to claim 1 wherein the transition metals, transition metal compounds or a combination thereof from the first, seventh or eighth transition groups.

8. The method according to claim 1, wherein the transition metals, transition metal compounds are rhodium, nickel, palladium, ruthenium, copper or a combination thereof.

9. The method according to claim 1, wherein the one or more acetylenic compounds (V) are acetylene, methylacetylene, 1-butyne, 1-hexyne, 2-hexyne, 1-octyne, 4-octyne, 1-butyn-4-ol, 2-butyn-1-ol, 3-butyn-1-ol, 5-hexyn-1-ol, 1-octyn-3-ol, 1-pentyne, phenylacetylene, trimethylsilylacetylene.

10. The method according to claim 1, wherein the hydrogen cyanide source is hydrogen cyanide, acetone cyanohydrin, formamide their alkali earth metal salts, their alkaline earth metal salts or a combination thereof.

11. The method according to claim 1, wherein the catalyst D is selected from the group consisting of metals, metal hydrides, metal hydroxides and metal alkoxides, mineral acids and a combination thereof.

12. The method according to claim 1, wherein the alcohol of the general formula M-OH is a linear or branched, saturated or unsaturated, monohydric organic alcohol having a carbon chain length of C₁-C₁₈ and the alcohol of the general formula M′-OH is linear or branched, saturated or unsaturated polyhydric organic alcohols having a carbon chain length of C₁-C₁₈.

13. A composition comprising a monocarboxyfunctionalized dialkylphosphinic acid, ester or salt according to claim 1, wherein the composition is an intermediate for further syntheses, a binder, a crosslinker to cure epoxy resins, polyurethanes and unsaturated polyester resins, an accelerant to cure epoxy resins, polyurethanes and unsaturated polyester resins, a polymer stabilizer, a crop protection agent, a therapeutic or additive in therapeutics for humans and animals, a sequestrant, a mineral oil additive, a corrosion control agent, a washing or cleaning application or an electronic application.

14. A composition comprising a monocarboxyfunctionalized dialkylphosphinic acid, ester or salt according to claim 1, wherein the composition is a flame retardant, a flame retardant for clearcoats or intumescent coatings, a flame retardant for wood or other cellulosic products, a reactive flame retardant for polymers, a nonreactive flame retardant for polymers, a flame-retardant polymeric molding material, a flame-retardant polymeric molded article or a flame-retardant finishing of polyester and cellulose straight and blend fabrics by impregnation.

15. A flame-retardant thermoplastic or thermoset polymeric molding material 0.5% to 45% by weight of a monocarboxyfunctionalized dialkylphosphinic acid, ester or salt according to claim 1, 0.5% to 95% by weight of a thermoplastic or thermoset polymer or mixtures thereof, 0% to 55% by weight of additives and 0% to 55% by weight of filler or reinforcing materials, wherein the sum total of the components is 100% by weight.

16. Flame-retardant thermoplastic or thermoset polymeric molded articles, films, threads or fibers comprising 0.5% to 45% by weight of a monocarboxy-functionalized dialkylphosphinic acid, ester, or salt according to claim 1, 0.5% to 95% by weight of a thermoplastic or thermoset polymer or mixtures thereof, 0% to 55% by weight of additives and 0% to 55% by weight of filler or reinforcing materials, wherein the sum total of the components is 100% by weight.
